(19) United States
(12) Patent Application Publication
(10) Pub. No.: US 2019/0316291 A1
(43) Pub. Date: Oct. 17, 2019

(54) Self-Contained Mobile Finishing Center for Garment Finishing

(71) Applicants: Levi Strauss & Co., San Francisco, CA (US); Jeanologia S. L., Paterna (ES)

(72) Inventors: James Barton Sights, San Francisco, CA (US); Liz O'Neill, Tiburon, CA (US); Jeff Zens, Emeryville, CA (US); Benjamin Bell, San Francisco, CA (US); Jennifer Schultz, San Francisco, CA (US); Debdulal Mahanty, Fremont, CA (US); Ozgur Taylan Kuzucu, Walnut Creek, CA (US); Christopher Schultz, San Francisco, CA (US); Vicente Albert, Onteniente (ES); Albert Sans, Terrassa (ES); Josep Maria Carbonell, Vilassar de Mar (ES)

(21) Appl. No.: 16/288,090

(22) Filed: Feb. 27, 2019

Related U.S. Application Data
(60) Provisional application No. 62/636,115, filed on Feb. 27, 2018.

(51) Int. Cl. D06M 10/00; D06C 23/02; G06Q 30/06; G06T 11/00

(52) U.S. Cl. CPC D06M 10/005; D06C 23/02; G06T 2210/16; G06Q 30/0643; G06T 11/00; G06Q 30/0621

(57) ABSTRACT

A self-contained mobile finishing garment center includes two containers that include a computer-controlled system that laser finishes garments ordered by customers. A first container includes an order system and a laser that laser forms a customer ordered wear pattern into the fabric of a garment, such as jeans. A second container includes wet processing equipment, such as a clothes washer and a clothes dryer that wash and dry the garment. The self-contained mobile finishing center facilitates the receipt of a custom order for jeans and the laser finishing and delivery of the jeans in a relatively short time, such as in less than an hour. The containers are mobile and can be shipped by truck, rail, or ship to a variety of locations and events for custom finishing garments according to customer's custom orders to provide custom ordered garment in a short time period, such as during an event.

### CROSS REFERENCE TO RELATED APPLICATIONS

This patent application claims the benefit of U.S. patent application 62/636,115, filed Feb. 27, 2018. This application is incorporated by reference along with all other references cited in this application.

### BACKGROUND OF THE INVENTION

The present invention relates to apparel manufacturing and, more specifically, to manufacturing using a self-contained mobile laser finishing center for finishing garments to have a faded, distressed, washed, or worn finish or desired appearance. The mobile finishing center can be driven to a location such as sporting events (e.g., Super Bowl), concerts (e.g., Coachella), or another special event, at which garments can be processed on site.

In 1853, during the California Gold Rush, Levi Strauss, a 24-year-old German immigrant, left New York for San Francisco with a small supply of dry goods with the intention of opening a branch of his brother's New York dry goods business. Shortly after arriving in San Francisco, Mr. Strauss realized that the miners and prospectors (called the “forty-niners”) needed pants strong enough to last through the hard work conditions they endured. So, Mr. Strauss developed the now familiar jeans which he sold to the miners. The company he founded, Levi Strauss & Co., still sells jeans and is the most widely known jeans brand in the world. Levi's is a trademark of Levi Strauss & Co. or LS&Co.

Though jeans at the time of the Gold Rush were used as work clothes, jeans have evolved to be fashionably worn every day by men and women, showing up on billboards, television commercials, and fashion runways. Fashion is one of the largest consumer industries in the U.S. and around the world. Jeans and related apparel are a significant segment of the industry.

In 1994, Jeanologia was founded by Jose Vidal and his nephew Enrique Silla in Valencia, Spain. They have developed sustainable and eco-efficient technologies for the fabric and garment finishing industry. Jeanologia's technology offers solutions with the maximum cost-effectiveness for the textile and other industries, enhancing industrial productivity, providing energy efficiency, reducing water consumption, and eliminating damaging emissions and waste. Jeanologia is a trademark of Jeanologia S.L.

As fashion, people are concerned with the appearance of their jeans. Many people desire a faded or worn blue jeans look. In the past, jeans became faded or distressed through normal wash and wear. The apparel industry recognized people's desire for the worn blue jeans look and began producing jeans and apparel with a variety of wear patterns. The wear patterns have become part of the jeans style and fashion. Some examples of wear patterns include combs or honeycombs, whiskers, stacks, crackle, and train tracks.

Despite the widespread success jeans have enjoyed, the process to produce modern jeans with wear patterns takes processing time, has relatively high processing cost, and is resource intensive. A typical process to produce jeans uses significant amounts of water, chemicals (e.g., bleaching or oxidizing agents), ozone, enzymes, and pumice stone. For example, it may take about 20 to 60 liters of water to finish each pair of jeans.

Therefore, there is a need for a technique for finishing garments that also reduces environmental impact, processing time, and processing costs, while maintaining the look and style of traditional finishing techniques.

### BRIEF SUMMARY OF THE INVENTION

A mobile finishing center includes a laser to finish garments to have a faded, distressed, washed, or worn finish or desired appearance. The mobile finishing center is self-contained and can be driven to a location where consumers can select, view a preview of apparel products, order apparel products, and then the products will be manufactured on site. The mobile finishing center has a closed-loop water recycling and filtration system, where water is cleaned and reused continuously as products are manufactured.

A system of the mobile finishing center includes a tool that allows a customer to preview or create new designs for apparel before purchase and before laser finishing. Software and lasers are used in finishing apparel to produce a desired wear pattern or other design. Based on a laser input file with a pattern, a laser will burn or ablate the pattern onto apparel. With the tool, the customer will be able to preview, create, make changes, and view images of a design, in real time, before purchase and burning or ablation by a laser. Input to the tool can include fabric template images, laser input files, and damage input. In an implementation, the customer or other user can also move, rotate, scale, and warp the image input.

In a specific implementation, a self-contained mobile finishing center is housed within two 12.2-meter (40-foot) shipping containers. A first container includes a showroom and a dry processing room. In the showroom, garments and patterns that may be applied to the garments may be previewed using the tool for garment and pattern preview. The dry processing room includes a laser finishing system that laser forms a customer-ordered wear pattern into the fabric of a garment, such as a pair of jeans. A second container includes a wet processing room and water recycling room. The wet processing room includes clothes washers and clothes dryers that wash and dry the customer ordered garment. After drying, the garment has the appearance of the preview. The water recycling room supplies water to the washers and recycles the waste water from the washer for reuse in subsequent washer loads.

The self-contained mobile finishing center allows customers to see, select, customize, and order apparel products. The laser will laser finish an ordered garment (e.g., jeans) to have a faded, distressed, washed, or worn finish or desired appearance. The garment is washed and dried and available for the customer in a relatively short time. For example, an order made at the beginning of a football game can be ready for pick up during half time or at the end of the game. In a specific implementation, an order is ready for pick up about an hour after the order is made.

The containers of the finishing center are mobile and can be driven by truck or shipped by rail or ship to any desired location for any desired event. After arriving at a location, the containers are set up and connected to an electricity source (e.g., power line, electric generator, batteries, or solar panels). A connection to a water source and drainage are not needed. Then the finishing center will be ready to accept customers' orders and will manufacture finished garments, which will be ready in a short time period.

In an implementation, a system includes a first intermodal shipping container. The container has a first length, a first width, and a first height compliant with universal shipping container dimensions and configurations dictated by the International Organization for Standardization (ISO). The first length extends in a first direction. The first width extends in a second direction, transverse to the first direction. The first height extends in a third direction, transverse to the first and second directions.

There is a first computing device with a display, a user input interface, and a software application program with code executable on a processor of the first computing device. There is an software application program having code to receive a first user selection through the user input interface of a base template from a number of base templates for a garment to manufacture using the system, code to receive a second user selection through the user input interface of a pattern from a number of patterns for the garment to manufacture, and code to generate a preview image on the display of the selected base template and the selected pattern such that an appearance of the preview image is representative of the garment after manufacture.

The first intermodal shipping container has a laser device having a laser head with a laser beam output. A workpiece surface positioned at a first distance from the laser head. A first memory of the laser will receive a laser input file associated with the selected pattern selected at the first computing device. Via the laser head, a laser beam is emitted through the laser beam output and is capable of striking a number of positions of the workpiece surface.

During manufacture of the garment, based on the laser input file in the first memory, the laser device will direct the laser beam to create the selected pattern on an outer surface of a garment, corresponding to the selected base template, that is placed on the workpiece surface.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a block diagram of a system for interacting with customers and creating, designing, producing apparel products with laser finishing based on the customer interaction.

FIG. 2 is a simplified block diagram of a distributed computer network incorporating an embodiment of the present invention.

FIG. 3 shows an exemplary client or server system, in an implementation.

FIG. 4 shows a system block diagram of a computer system used to execute the software, in an implementation.

FIGS. 5-6 show examples of mobile devices that can be mobile clients.

FIG. 7 shows a system block diagram of a mobile device used to execute the software of the present invention.

FIG. 8 shows a block diagram of an order tool where each block is a software module that is adapted to be stored and run on a select and order system, in an implementation.

FIG. 9 shows a screen capture including some images of laser finishing patterns, stored in laser input files, which are available for a customer to select from.

FIG. 10 shows a screen capture of a preview of jeans with a selected laser finishing pattern positioned onto a front of the jeans.

FIG. 11 shows a computer system of the select and order system, which shows a preview of the jeans before manufacture.

FIG. 12 shows a technique of generating a preview of the jeans based on a base template image, an adjusted base template image, and a laser input file which contains the laser finishing pattern.

FIG. 13 shows a flow diagram for a garment finishing method, in an implementation.

FIG. 14 shows a laser beam striking ring-dyed yarn fiber having indigo-dyed fibers in an outer ring and white core fibers inside the outer ring in the core of the fiber.

FIG. 15 shows the laser using a first power level setting or first exposure time setting, or a combination of these, to remove a portion of the dyed fibers of the outer ring, but not revealing any of the white core fibers.

FIG. 16 shows the laser using a second power level setting or second exposure time setting, or a combination of these, to remove more of the dyed fibers than in FIG. 15.

FIG. 17 shows the laser using a third power level setting or third exposure time setting, or a combination of these, to remove even more of the dyed fibers of the ring than in FIG. 16.

FIG. 18A shows a self-contained mobile finishing center, in an implementation.

FIG. 18B shows the washer connected with the water recycling system, in an implementation.

FIG. 19 shows a view of the laser process container and a postlaser process container (also referred to as a wet process container) from a central location between the containers.

FIG. 20 shows a side view of the laser process container, the showroom, and the dry process room with the computer controlled laser system in the dry process room.

FIG. 21 shows a side view of the postlaser process container and the wet process room with the clothes washers and dryers in the room.

FIG. 22 shows an interior view of the wet process room with the clothes washers and dryers in the room.

FIG. 23 shows the laser process and postlaser process containers loaded on truck trailers of trucks adapted to transport the containers between use locations.

FIG. 24 shows a side view of one of the truck trailers and one of the trucks with one of the containers (e.g., a 12.2-meter (40-foot) long container) on the trailer.

FIGS. 25-26 show a front view and a top view, respectively, of the computer-controlled laser system.

FIG. 27A shows a laser of the laser system located in a laser cabinet.

FIG. 27B shows the laser and the laser head of the laser, in an implementation.

FIG. 27C shows the laser and the laser head of the laser, in an implementation.

FIGS. 28-29 show exterior and interior components of the laser system in a planar front view and a planar side view.

### DETAILED DESCRIPTION OF THE INVENTION

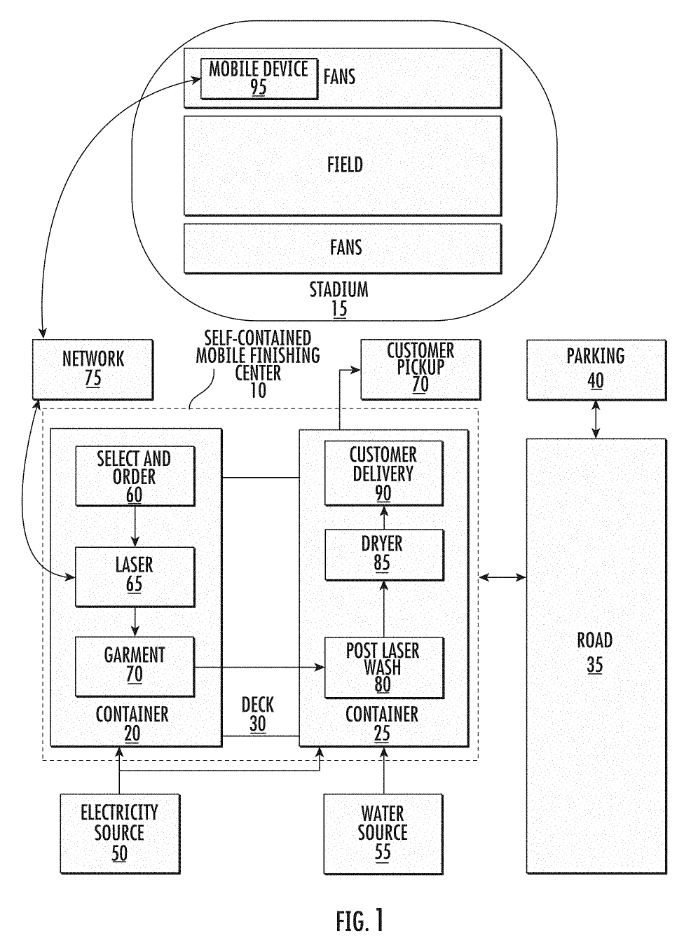

FIG. 1 shows a block diagram of a system for interacting with customers and designing and producing apparel products with laser finishing using information collected from the customers. The system includes a self-contained mobile finishing center 10 that can be moved to and from various locations that consumers visit for convenient customer access. The mobile finishing center can be setup at a variety of locations, such as stadium 15 where sporting events are played, at concerts, at fairs and festivals, at shopping centers, at shopping malls, at parks, in downtown areas, at beaches, at resorts, at amusement parks, at racetracks, at school campuses, at corporate buildings and campuses, and other locations.

The mobile finishing center includes a first container 20 and a second container 25. The center can include more or fewer containers, such as 1, 3, 4, 5, or another number. The number of containers can be increased or decreased based on the size and configuration of an open space where the containers are placed for use, based on the number of pieces of equipment (e.g., number of select and order systems 60, number of computer-controlled laser systems 65, number of clothes washers 80 and dryers 85, or others). The clothes washer, dryers, or both may be operated in a time stagger manner so that batches of garments may be delivered within times that are less than the washing times and drying times.

The containers can be linked by a deck 30 that allows people to conveniently move between the containers and move garments between the containers. The deck forms a walkway for people to move between the containers. The deck has a surface that has a height that approximately matches the heights of raised floors of the containers. With the three heights matching, devices that are designed to roll, such as carts and dollies, can conveniently be rolled from one container to another and people can conveniently move between the containers quickly without having to step up or step down. The deck can be a folding deck that folds up onto or into one of the containers. The deck can be separable from the containers for storage and transport between locations. For example, the deck can be stored on top of one of the containers for transport. The containers can include doors or openings formed in sides of the containers. The sides of the container having the doors or openings may face each other when the containers are setup to finish garments. The doors can be sliding doors or sliding glass doors that open towards the deck. A first door of the first container and a second door of the second container can face each other or be aligned where a line between the doors is transverse to a longitudinal axis of the deck providing an approximately shortest possible distance of travel between the two doors. Thus, travel distance and time between the two containers is minimized. The doors (e.g., sliding doors) can be transparent and can be formed of glass or a plastic material. The containers can include one or more windows along the sides or roofs of the containers. The openings and doors extend in lateral and horizontal dimension of the containers. The openings and doors allow a view of the equipment and machines in the containers. Customers can view the equipment and machines in the containers, such as when an ordered garment is being laser finished, washed, and dried in the containers. The deck between the containers can join the openings in the sides of the containers.

The containers can be shipping containers that fit onto conventional transportation vehicles for being moved between locations where the mobile finishing center will be used for finishing garments or stored. The containers can be intermodal shipping containers having lengths, widths, and heights compliant with universal shipping container dimensions and configurations dictated by the International Organization for Standardization. Intermodal shipping containers may be shipped by a variety of transport devices, such as on trailers that are towed by trucks, on cargo ships, on railroad cars, any combination of these transport devices, or other transport devices. The shipping containers may be formed of one or more of a variety of materials, such as steel (e.g., corrugated steel), wood, or other materials.

The shipping containers have standard sizes which allow the containers to be put onto truck trailers for truck transportation on a roadway 35, onto train cars for rail transportation, or onto ships for ship transportation. The containers can be moved by 1, 2, 3, or 4 or more trucks on 1, 2, 3, or 4, or more trailers. The containers can be picked up and removed from the trucks that transport the containers to a location and placed on the ground. The trucks transporting the containers can then be removed from the location, such as to a parking facility 40, to provide for optimum open space near the trailers and to allow the area near the containers and the containers to be more inviting for approach by customers. One or both of the trucks can include one or more storage locations for transporting the deck. Alternatively, the deck can be attached to (e.g., fold up onto) one of the containers for transport.

The shipping containers can have standard lengths, such as 2.43 meters (8 feet), 2.99 meters (9 feet 10 inches), 6.06 meters (20 feet), 12.2 meters (40 feet), or other lengths. The shipping containers can have standard widths, such as 2.2 meters (7 feet), 2.44 meters (8 feet), or other widths. The shipping containers can have standard heights, such as 2.27 meters (7.5 feet), 2.59 meters (8.5 feet), 2.89 meters (9.5 feet), or other heights. The standard lengths allow for ease of truck, train, and ship transportation. The deck can have the same length as the containers (e.g., 12.2 meters) or less, such as 11 meters and can have a width of 3.4 meters or other widths. A ramp can attach to the deck to allow for easy walk up to the deck.

The first and second containers are both adapted to be connected to an electricity source 50 that provides electrical power to the containers. The electricity source may be a private electrical power source or a municipal electrical power source. In an implementation, one or both of the containers includes a mobile power source, such as a generator, a battery power source, such as a lithium ion battery power source, solar panels, or another power source. If a container includes a mobile power source, the container may be adapted to operate without being connected to external electricity source 50. One or both of the containers is adapted to be connected to a water source 55 (e.g., an external water source, such as a private or municipal water source) that provides water to the containers. In an implementation, one or both of the containers include one or more water tanks that operate as mobile water sources for the containers. In an implementation, container 20 is not adapted to connect to a water source (e.g., does not include a water value or water port to connect to a water srouce), such as an external private water source or a municipal water source. If a container includes a mobile water source, the container may be adapted to operate without being connected to external water source 55. In an implementation, a storage tank included in container 25 can store 20 liters of water. In other implementations, the storage tank stores more or fewer liters of water, such as 15-25 liters of water.

In an implementation, container 20 includes a select and order system 60, a computer controlled laser system 65, and garments 70. The select and order system, the computer controlled laser system, or both are adapted to be connected to a network 75 (e.g., the Internet). The connection to the network can be a wired or wireless connection. In an implementation, the select and order system is adapted to be connected to the network. In the implementation, if the select and order system is connected to the network, the computer-controlled laser system does not directly have access to the network. For example, information from the network to the computer-controlled laser system is routed through the select and order system or other computing device, before receipt by the computer controlled laser system. In another implementation, the select and order system and the computer controlled laser system are both connected to the network. The network can additionally be connected to one or more mobile devices 95 that can communicate with the select and order system, the computer controlled laser system, or both via the network.

The computer controlled laser system includes one or more computer systems that receive order information from the network, from the select and order system, or both. The computer system of the computer-controlled laser system controls a laser of the system to perform laser a process on garments.

Container 25 includes a clothes washer 80, a clothes dryer 85, and a customer delivery area 90 where a finished garment may be delivered to a purchaser. In an implementation, the customer delivery area is outside of container 25, such as on the deck. In an implementation, the customer delivery area is located in container 20, such as in a showroom in the container. The elements of container 25 are adapted to clean and dry garments that have undergone laser processing in container 20.

Containers 20 and 25 may be shipped and used with one or more other containers, such as containers that are used to house and transport apparel that is to be laser finished by the a self-contained mobile finishing center 10. In an implementation, the deck may be transported on one of the other containers not including containers 20 and 25.

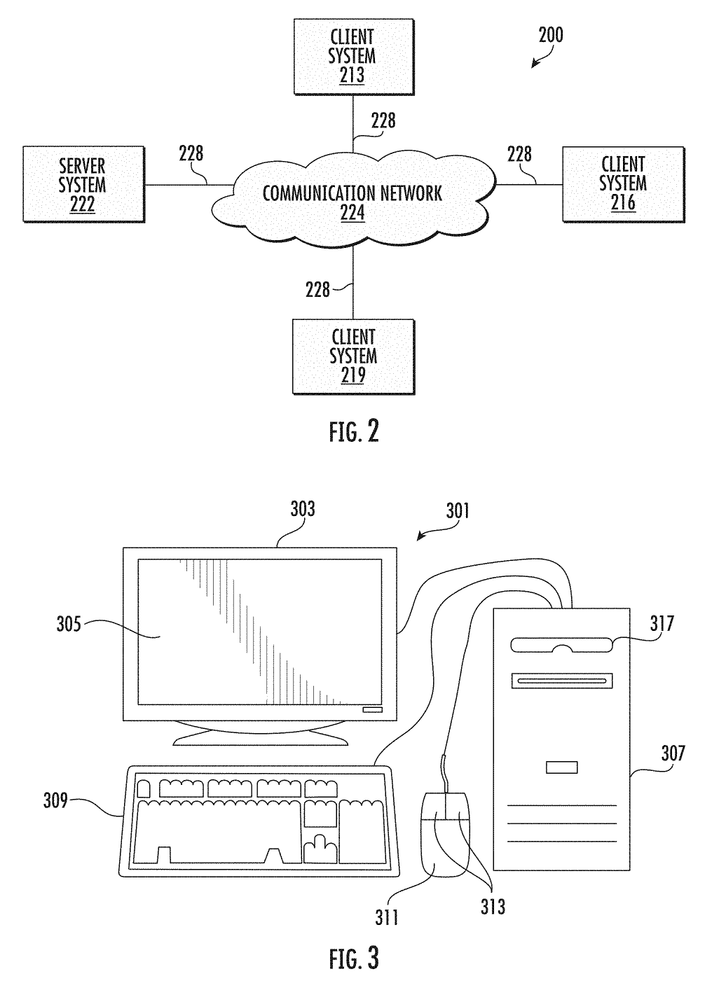

FIG. 2 is a simplified block diagram of a distributed computer network 200 incorporating an implementation of the present invention. Computer network 200 includes a number of client systems 213, 216, and 219, and a server system 222 coupled to a communication network 224 via a plurality of communication links 228. Communication network 224 provides a mechanism for allowing the various components of distributed network 200 to communicate and exchange information with each other.

Communication network 224 may itself be comprised of many interconnected computer systems and communication links. Communication links 228 may be hardwired links, optical links, satellite or other wireless communications links, wave propagation links, or any other mechanisms for communication of information. Communication links 228 may be DSL, Cable, Ethernet or other hardwire links, passive or active optical links, 3G, 3.5G, 4G and other mobility, satellite or other wireless communications links, wave propagation links, or any other mechanisms for communication of information.

Various communication protocols may be used to facilitate communication between the various systems shown in FIG. 2. These communication protocols may include VLAN, MPLS, TCP/IP, Tunneling, HTTP protocols, wireless application protocol (WAP), vendor-specific protocols, customized protocols, and others. While in one embodiment, communication network 224 is the Internet, in other embodiments, communication network 224 may be any suitable communication network including a local area network (LAN), a wide area network (WAN), a wireless network, an intranet, a private network, a public network, a switched network, and combinations of these, and the like.

Distributed computer network 200 in FIG. 2 is merely illustrative of an embodiment incorporating the present invention and does not limit the scope of the invention as recited in the claims. One of ordinary skill in the art would recognize other variations, modifications, and alternatives. For example, more than one server system 222 may be connected to communication network 224. As another example, a number of client systems 213, 216, and 219 may be coupled to communication network 224 via an access provider (not shown) or via some other server system.

Client systems 213, 216, and 219 typically request information from a server system which provides the information. For this reason, server systems typically have more computing and storage capacity than client systems. However, a particular computer system may act as both as a client or a server depending on whether the computer system is requesting or providing information. Additionally, although aspects of the invention have been described using a client-server environment, it should be apparent that the invention may also be embodied in a standalone computer system.

Server 222 is responsible for receiving information requests from client systems 213, 216, and 219, performing processing required to satisfy the requests, and for forwarding the results corresponding to the requests back to the requesting client system. The processing required to satisfy the request may be performed by server system 222 or may alternatively be delegated to other servers connected to communication network 224.

Client systems 213, 216, and 219 enable users to access and query information stored by server system 222. In a specific embodiment, the client systems can run as a standalone application such as a desktop application or mobile smartphone or tablet application. In another embodiment, a “Web browser” application executing on a client system enables users to select, access, retrieve, or query information stored by server system 222. Examples of Web browsers include the Internet Explorer browser program provided by Microsoft Corporation, Firefox browser provided by Mozilla, Chrome browser provided by Google, Safari browser provided by Apple, and others.

In a client-server environment, some resources (e.g., files, music, video, or data) are stored at the client while others are stored or delivered from elsewhere in the network, such as a server, and accessible via the network (e.g., the Internet). Therefore, the user's data can be stored in the network or “cloud.” For example, the user can work on documents on a client device that are stored remotely on the cloud (e.g., server). Data on the client device can be synchronized with the cloud.

FIG. 3 shows an exemplary client or server system 301. The client or server system can be the client or server systems of distributed computer network 200. In an implementation, a user interacts with the system through a computer workstation system, such as shown in FIG. 3. Computer system 301 includes a monitor 303, screen 305, enclosure 307 (may also be referred to as a system unit, cabinet, or case), keyboard or other human input device 309, and mouse or other pointing device 311. Mouse 311 may have one or more buttons such as mouse buttons 313.

It should be understood that the present invention is not limited any computing device in a specific form factor (e.g., desktop computer form factor), but can include all types of computing devices in various form factors. A user can interface with any computing device, including smartphones, personal computers, laptops, electronic tablet devices, global positioning system (GPS) receivers, portable media players, personal digital assistants (PDAs), other network access devices, and other processing devices capable of receiving or transmitting data.

For example, in a specific implementation, the client device can be a smartphone or tablet device, such as the Apple iPhone (e.g., Apple iPhone 6), Apple iPad (e.g., Apple iPad, Apple iPad Pro, or Apple iPad mini), Apple iPod (e.g., Apple iPod Touch), Samsung Galaxy product (e.g., Galaxy S series product or Galaxy Note series product), Google Nexus and Pixel devices (e.g., Google Nexus 6, Google Nexus 7, or Google Nexus 9), and Microsoft devices (e.g., Microsoft Surface tablet). Typically, a smartphone includes a telephony portion (and associated radios) and a computer portion, which are accessible via a touch screen display.

There is nonvolatile memory to store data of the telephone portion (e.g., contacts and phone numbers) and the computer portion (e.g., application programs including a browser, pictures, games, videos, and music). The smartphone typically includes a camera (e.g., front-facing camera or rear camera, or both) for taking pictures and video. For example, a smartphone or tablet can be used to take live video that can be streamed to one or more other devices.

Enclosure 307 houses familiar computer components, some of which are not shown, such as a processor, memory, mass storage devices 317, and the like. Mass storage devices 317 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive or solid state drive (SSD)), battery-backed-up volatile memory, tape storage, reader, and other similar media, and combinations of these.

A computer-implemented or computer-executable version or computer program product of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 317. The source code of the software of the present invention may also be stored or reside on mass storage device 317 (e.g., hard disk, magnetic disk, tape, or CD-ROM). As a further example, code of the invention may be transmitted via wires, radio waves, or through a network such as the Internet.

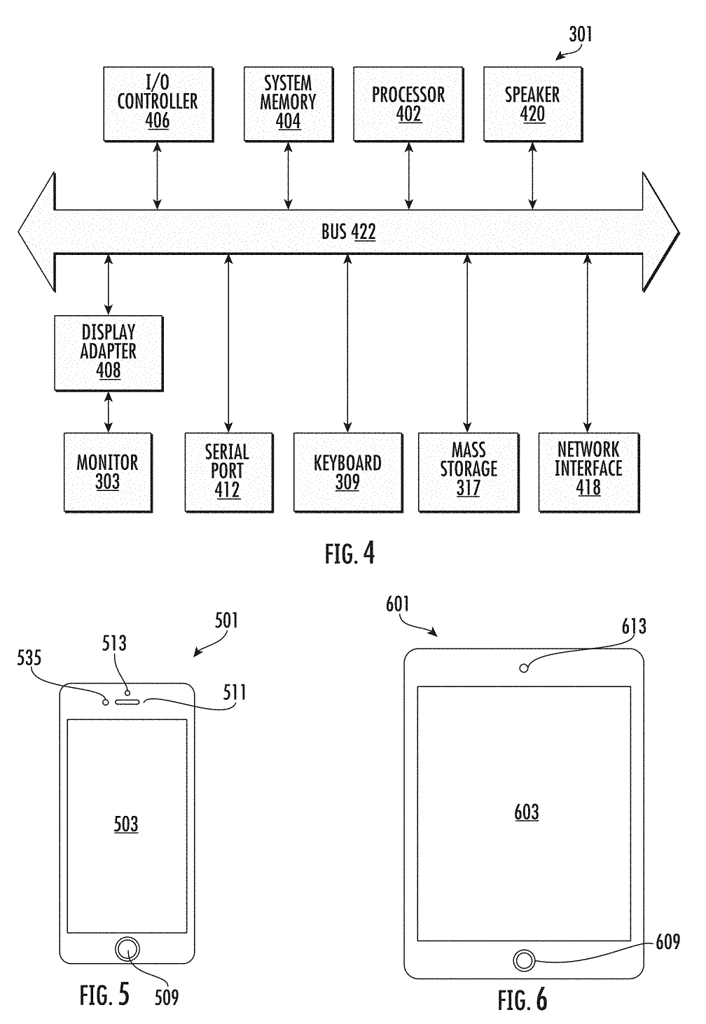

FIG. 4 shows a system block diagram of computer system 301 used to execute the software, in an implementation. As in FIG. 3, computer system 301 includes monitor 303, keyboard 309, and mass storage devices 317. Computer system 301 further includes subsystems such as central processor 402, system memory 404, input/output (I/O) controller 406, display adapter 408, serial or universal serial bus (USB) port 412, network interface 418, and speaker 420. The invention may also be used with computer systems with additional or fewer subsystems. For example, a computer system could include more than one processor 402 (i.e., a multiprocessor system) or a system may include a cache memory.

Arrows such as 422 represent the system bus architecture of computer system 301. However, these arrows are illustrative of any interconnection scheme serving to link the subsystems. For example, speaker 420 could be connected to the other subsystems through a port or have an internal direct connection to central processor 402. The processor may include multiple processors or a multicore processor, which may permit parallel processing of information. Computer system 301 shown in FIG. 4 is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, Matlab (from MathWorks, www.mathworks.com), SAS, SPSS, JavaScript, AJAX, Java, Python, Erlang, and Ruby on Rails. The computer software product may be an independent application with data input and data display modules. Alternatively, the computer software products may be classes that may be instantiated as distributed objects. The computer software products may also be component software such as Java Beans (from Oracle Corporation) or Enterprise Java Beans (EJB from Oracle Corporation).

An operating system for the system may be one of the Microsoft Windows® family of systems (e.g., Windows 95, 98, Me, Windows NT, Windows 2000, Windows XP, Windows XP x64 Edition, Windows Vista, Windows 7, Windows 8, Windows 10, Windows CE, Windows Mobile, Windows RT), Symbian OS, Tizen, Linux, HP-UX, UNIX, Sun OS, Solaris, Mac OS X, Apple iOS, Android, Alpha OS, AIX, IRIX32, or IRIX64. Other operating systems may be used. Microsoft Windows is a trademark of Microsoft Corporation.

Any trademarks or service marks used in this patent are property of their respective owner. Any company, product, or service names in this patent are for identification purposes only. Use of these names, logos, and brands does not imply endorsement.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, 802.11ac, and 802.11ad, just to name a few examples), near field communication (NFC), radio-frequency identification (RFID), mobile or cellular wireless (e.g., 2G, 3G, 4G, 3GPP LTE, WiMAX, LTE, LTE Advanced, Flash-OFDM, HIPERMAN, iBurst, EDGE Evolution, UMTS, UMTS-TDD, 1×RDD, and EV-DO). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download Web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

In other implementations, the user accesses the system through either or both of native and nonnative applications. Native applications are locally installed on the particular computing system and are specific to the operating system or one or more hardware devices of that computing system, or a combination of these. These applications (which are sometimes also referred to as “apps”) can be updated (e.g., periodically) via a direct internet upgrade patching mechanism or through an applications store (e.g., Apple iTunes and App store, Google Play store, Windows Phone store, and Blackberry App World store).

The system can run in platform-independent, nonnative applications. For example, client can access the system through a Web application from one or more servers using a network connection with the server or servers and load the Web application in a Web browser. For example, a Web application can be downloaded from an application server over the Internet by a Web browser. Nonnative applications can also be obtained from other sources, such as a disk.

FIGS. 5-6 show examples of mobile devices that can be mobile clients. Mobile devices are specific implementations of a computer, such as described above, and can be the client systems or server systems of distributed computer network 200. FIG. 5 shows a smartphone device 501, and FIG. 6 shows a tablet device 601. Some examples of smartphones include the Apple iPhone, Samsung Galaxy, and Google Nexus family of devices. Some examples of tablet devices include the Apple iPad, Apple iPad Pro, Samsung Galaxy Tab, and Google Nexus family of devices.

Smartphone 501 has an enclosure that includes a screen 503, button 509, speaker 511, camera 513, and proximity sensor 535. The screen can be a touch screen that detects and accepts input from finger touch or a stylus. The technology of the touch screen can be a resistive, capacitive, infrared grid, optical imaging, pressure-sensitive, dispersive signal, acoustic pulse recognition, or others. The touch screen is a screen and a user input device interface that acts as a mouse and keyboard of a computer.

Button 509 is sometimes referred to as a home button and is used to exit a program and return the user to the home screen. The phone may also include other buttons (not shown) such as volume buttons and on-off button on a side. The proximity detector can detect a user's face that is close to the phone, and can disable the phone screen and its touch sensor, so that there will be no false inputs from the user's face being next to the screen when talking.

Tablet 601 is similar to a smartphone. Tablet 601 has an enclosure that includes a screen 603, button 609, and camera 613. Typically the screen (e.g., touch screen) of a tablet is larger than a smartphone, usually 7, 8, 9, 10, 12, 13, or more inches (measured diagonally).

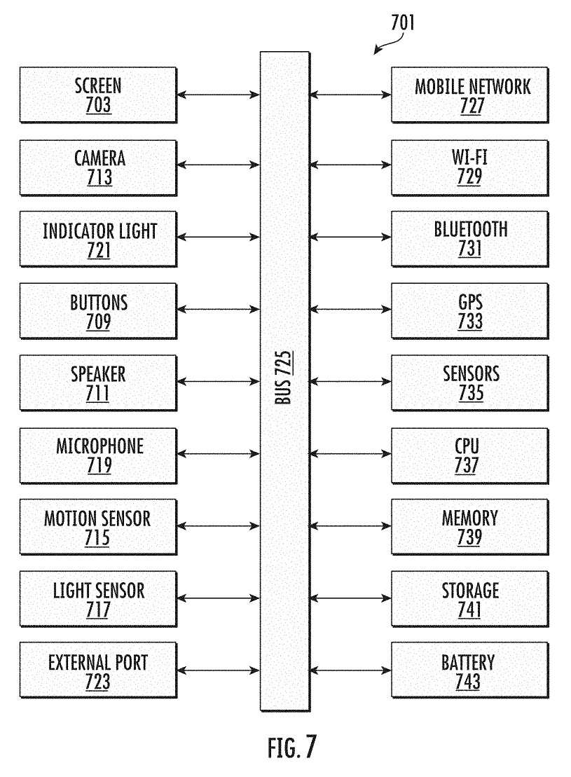

FIG. 7 shows a system block diagram of mobile device 701 used to execute the software of the present invention. This block diagram is representative of the components of the smartphone or tablet device. The mobile device system includes a screen 703 (e.g., touch screen), buttons 709, speaker 711, camera 713, motion sensor 715, light sensor 717, microphone 719, indicator light 721, and external port 723 (e.g., USB port or Apple Lightning port). These components can communicate with each other via a bus 725.

The system includes wireless components such as a mobile network connection 727 (e.g., mobile telephone or mobile data), Wi-Fi 729, Bluetooth 731, GPS 1533 (e.g., detect GPS positioning), other sensors 735 such as a proximity sensor, CPU 737, RAM memory 739, storage 741 (e.g. nonvolatile memory), and battery 743 (lithium ion or lithium polymer cell). The wireless components can connect wirelessly to the client systems or server systems of distributed computer network 200. The battery supplies power to the electronic components and is rechargeable, which allows the system to be mobile.

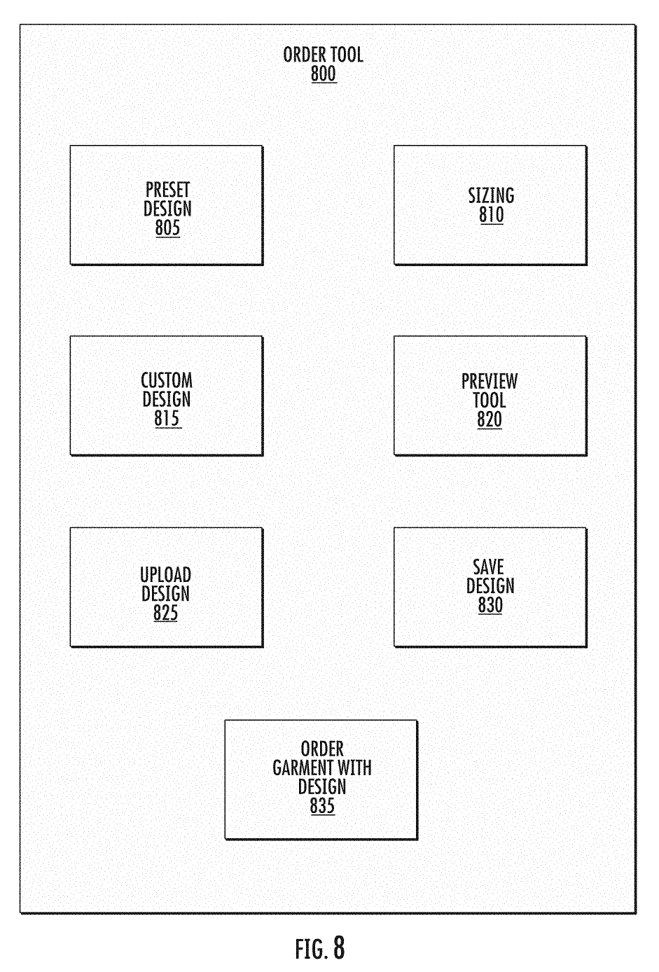

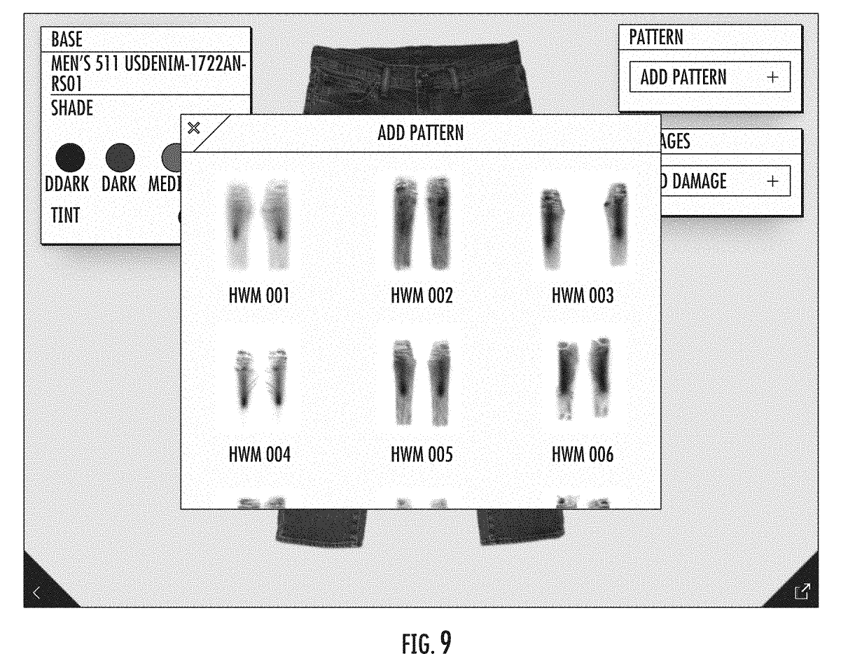

FIG. 8 shows a block diagram of an order tool 800 where each block is a module of computer code that is adapted to be stored and run on select and order system 60, in an implementation. The select and order system may include one or more order and preview computers that may be configured as shown in any of FIGS. 3-7 in any combination and as described in this patent. The one or more order and preview computers may perform any of the functions of the select and order system and may operate one or more of the software modules described in this patent in any combination.

The select and order system may store and run the modules of the order tool in container 20. In an implementation, the select and order system is stored and run on one or more mobile devices 95 of customers (e.g., fans at a sporting event or other event). The mobile devices can include smartphones, tablet computers, laptop computers, or other devices. More specifically, the order tool is adapted to run on a computer system of the select and order system, such as a tablet computer. If the select and order system includes a number of computers systems, such as a number of tablet computers, then multiple instances of the select and order system are run on the computer systems.

The order tool includes a number of preset designs 805 that can be applied to garments, such as jeans, by the laser of the computer controlled laser system. Each preset design includes information for a wear pattern that can be applied to a garment. Examples of wear patterns include a comb or a honeycomb pattern, a whisker pattern, a stack pattern, a crackle pattern, and a train track pattern. The preset design information can include graphical information that allows the preset design to be displayed on a display of the computer system (e.g., display of a tablet computer) of the select and order system.

The order tool provides for displaying (i.e., previewing) a number of preset designs that a customer might want formed on a garment by the laser. The order tool also provides for user selection of a preset design for the particular design that a customer selects for being formed on a garment by the laser. Selections can be received by the select and order system by a variety of input devices, such as a touch screen of a tablet computer, a computer mouse, a keyboard, or other human interface devices.

The order tool includes a custom design tool 815. The custom design tool provides for the user selection of a custom design that a customer would like formed on a garment by the laser.

A custom design is a design that is not included in a preset design. A custom design that is selected by a customer can be formed on a garment with or without a preset design. Custom designs can be created by a user using the custom design tool or other tools or can be provided by the order tool for preview and selection by a user. In an implementation, the custom design tool displays a custom design interface on the display of the computer system of the select and order system. The custom design interface provides tools allowing the customer to create a custom design. The custom design interface can provide preset custom designs that are customer selectable. The custom design interface can include a drawing interface that allows a user to draw a custom design or modify a preset custom design that is selected by a customer. The custom design interface can include a text interface that allows a customer to enter text for a custom design. The custom design interface can receive input via a touch display (e.g., of a tablet computer) that the custom design interface is displayed on or can receive input via one or more human interface devices.

A custom design includes one or more of a variety of images, symbols, letters, numbers, or other graphics. A custom design can be a design that commemorates a sporting event, identifies a sports team, includes a corporate logo, or others. An organization, for example a corporation or a sports team, can have one or more custom designs prepared for an event at which customers can select the custom designs. For example, a corporation that has the mobile finish center at an event at a corporate campus can have one or more custom design prepared for employee selection for forming on corporate garments by the laser.

The order tool includes a sizing tool 810 that includes size information for garments that are available for purchase at the mobile finishing center. The size information can be for sizes of denim products, such as jeans. The techniques and approaches described are applicable to other apparel and products such as shirts, shorts, jackets, vests, skirts, vests, shoes, handbags, and others. The size information can be displayed on a display of the computer system of the select and order system, and customers can select sizes of garments from the displayed size information. The size information can be organized and displayed according to body shape (e.g., inseam length, waist size, hip size, or others), styles (e.g., skinny jeans, regular fit, boyfriend style, baggy, boot cut, or others), gender preferences, or others.

The sizing tool can include graphical information that includes images of garments having the sizes of the size information. Images of garments of different sizes can be displayed on the display of the computer system to aid customers select garments having preferred sizes. Size information can also be displayed in numerical format, as dynamic graphical interfaces (e.g., slider bars, radio button, or others), or others that can be manipulated by customers for size selection of garments.

The sizing tool can also provide information for color selection (e.g., black, indigo, brown, green, khaki, or other colors) of garments where the information for color selection is displayed on the display of the computer system of the select and order tool. Colors can be selected as described above via a touch display or other human interface devices.

The order tool includes a preview tool 820. The preview tool provides image information for the computer system to display an image of the garment that a customer has selected. The preview tool provides for the selected garment to be displayed in the selected size, in the selected color, and with the selected preset design or the selected custom design or both. The display screen of the selected garment can include a screen element that can be selected to save the design for subsequent order and purchase. The order tool includes a save design tool 830 that saves final information that identifies the selected garment in the selected size, in the selected color, with the selected preset design, the selected custom design, or any combination of these.

The order tool includes an upload design tool 825. The upload design tool uploads the final information to the computer controlled laser system 65. The order design tool also includes an order tool 835 via which an order for the selected garment and design is placed for purchase.

FIG. 9 shows some laser finishing patterns, stored in laser input files, which are available for a customer to select from. The screen shows nine different laser patterns from which the customer or user can select from. There can be any number of laser patterns provided by the apparel manufacturer. Also, a customer may choose to upload their own laser file or retrieve a previously saved laser file.

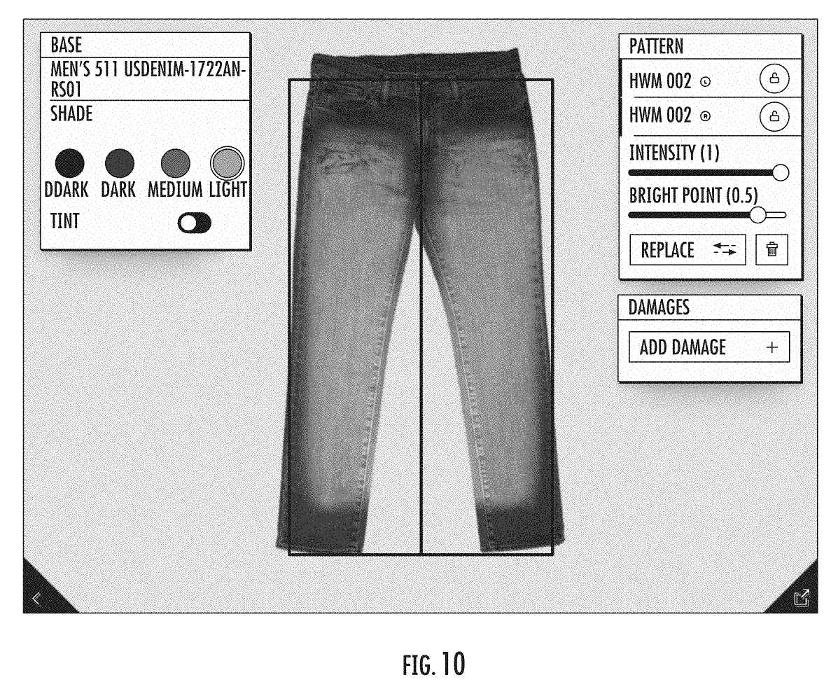

FIG. 10 shows a preview of jeans with a selected laser finishing pattern positioned onto a front (i.e., outer surface) of a selected base template of jeans. There can be a number of base templates to choose from, such as dark dark (e.g., which may be referred to as ddark), dark, medium, and light, as indicated on the screen. Further, the user can make other adjustments such as changing to a different laser pattern, changing an intensity of the pattern, changing a bright point of the pattern, or adding damage to the design.

For any changes the user makes, the user will see changes in the preview image in real-time. The preview shows the user how the jeans will appear after it is manufactured by the mobile laser-finishing center. By selecting different combinations of laser files and base jean templates, a customer can create numerous different jean designs and have these manufactured by the mobile laser-finishing center.

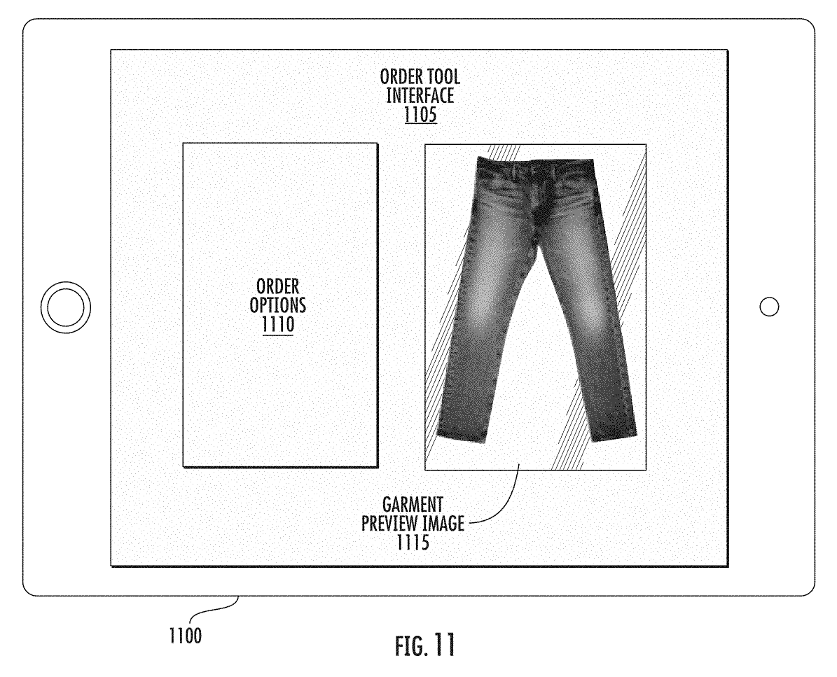

FIG. 11 shows a computer system 1100 of select and order system 60, in an implementation. The computer system of the select and order system is operated for garment orders in container 20. The computer system can be a tablet computer, a personal computer, a laptop computer, smartphone, or others. The computer system is adapted to store and run computer code for the order tool 800. That is, the computer system is adapted to store and run computer code for the present design tool 805, the sizing tool 810, the custom design tool 815, the preview tool 820, the upload design tool 825, the save design tool 830, and the order garment with design tool 835. These software tools are sometimes referred to as software modules or simply modules.

An order tool interface 1105 of the select and order system is shown in FIG. 11. Order tool interface 1105 includes a menu 1110 for order options, such as order options for one or more of the preset design tool (e.g., display preset one or more preset designs), the sizing tool (e.g., sizing options), the custom design tool (e.g., a custom design tool interface, preset custom designs, or both), the preview tool, the upload design tool, the save design tool, and the order garment with design tool. Order options that are displayed in the menu can be selected by a customer, via a touch screen of the computer system, a human interaction device, or others.

In an implementation, the order tool interface displays a garment preview image 1115 of the preview tool in combinations with the order options displayed in the menu. The order tool interface can be adapted to update the garment preview image as various order options are selected from the menu. For example, if a preset design with whiskers is selected from the order options, then the garment preview image (e.g., jeans) is displayed with whiskers. If the present design for whiskers is deselected, then the garment preview image is displayed without whiskers. While the garment preview image is jeans, the image can be any selected garment, bag, or others.

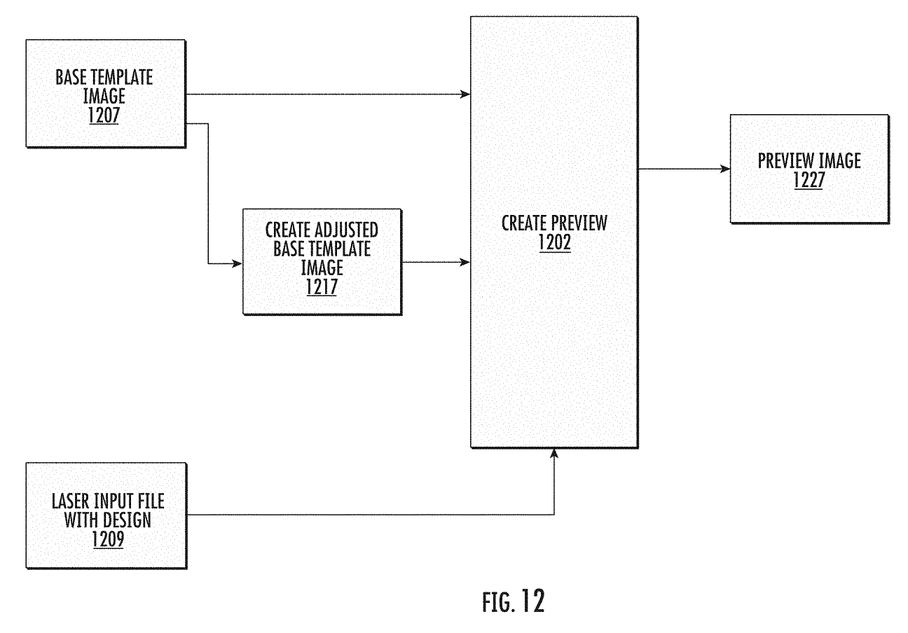

FIG. 12 shows a technique of generating of a laser-finishing pattern on a garment, such as jeans based on a base template image, an adjusted base template image, and a laser input file which contains the laser finishing pattern. Inputs to a create preview image process 1202 include a base template image 1207 and laser input file 1209. The base template image is used to create an adjusted base template image 1217, which is also input to the create preview image process. These create preview image process uses these three inputs to create a preview image 1227, which can be displayed on a computer screen for the user.

The adjusted base template image is created from the base template image by adjusting its hue, saturation, or lightness, or any combination of these. Compared to the original base template image, the adjusted base template image will appear washed out or bleached. In other words, the adjusted base template image will appear as if the garment in the base template image were fully bleached or lasered.

For a specific implementation of a laser, a specification for the laser input file is that each pixel is represented by an 8-bit binary value, which represents grayscale value in a range from 0 to 255. A 0 black prints the highest intensity (i.e., creates the most change and will be the lightest possible pixel) and a 255 white does not print at all (i.e., creates the least change or will be the darkest possible pixel).

For a laser input file for this laser implementation, a reverse or negative image of the laser input file is input to the create preview image process. Based on the negative laser input file, to create each pixel in the preview image, the create preview image process will pass pixels of the base template image or the adjusted base template image, or a combination of these.

For the negative laser input file, a black pixel means the pixel (which was a white pixel in the original file) will not be lasered (which results in the original indigo color of the fabric). And a white pixel means the pixel (which was black in the original file) will be lasered at highest level (which results in the whitest color that can be achieved on the fabric). And for gray pixels between black and white, the result will be proportional to the value, somewhere between darkest and lightest colors.

Similarly, to create the preview image, based the negative laser input file, a pixel of a (1) base template image (e.g., unbleached) or (2) adjusted base template image (e.g., bleached) or (3) some mixture or combination of the base template image and adjusted base template image proportional to the grayscale value in the negative laser input file. For example, for a gray value in the negative laser input file, 60 percent of the base layer and 40 percent of the adjustment layer pass through to the preview image.

The above discussion described a laser input file conforming to one type of logic. However, in other implementations of a laser, the values in the laser input file can be the reverse or negative logic compared to that described above. As one of ordinary skill in the art would appreciate, the techniques described in this patent can be modified accordingly to work with negative or positive logic laser input files.

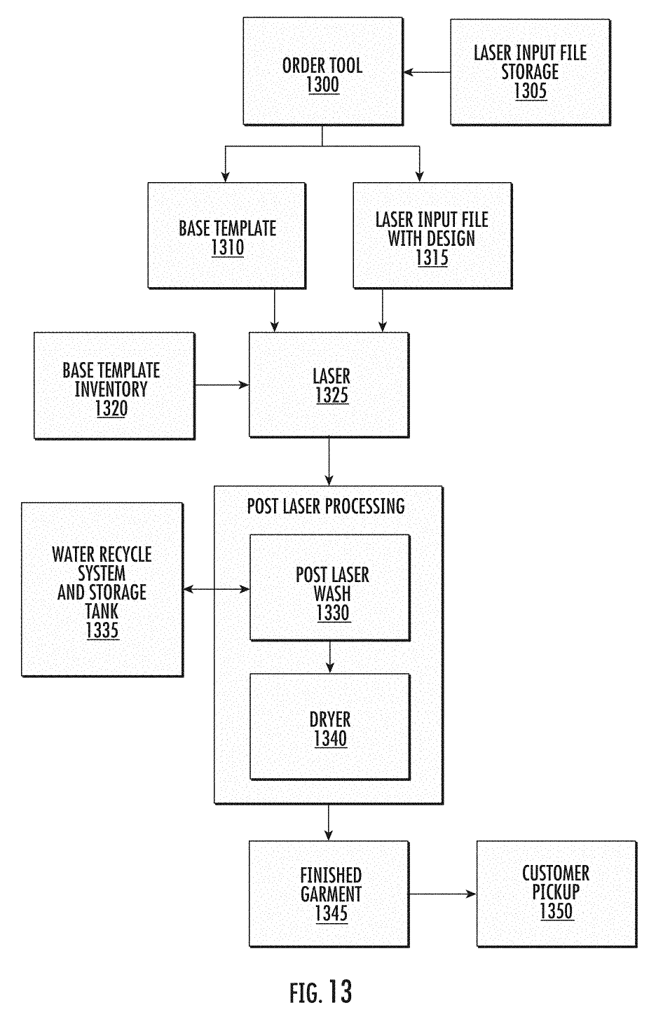

FIG. 13 shows a flow diagram for a garment finishing method, in an implementation. Steps can be added to the flow diagram, combined in the diagram, removed from the diagram, or any combination of these without deviating from the intent of the method.

At 1300, the order tool, which is stored and operates on the computer system of the select and order system or on a customer mobile device, receives an order for a garment having a wear pattern. The order system includes code to receive a first user selection of a base template for the garment from a number of base templates for a number of garments including and includes code to receive a second user selection for a pattern (e.g., a wear pattern) from a number of patterns. The first and second user selections form a portion of the order or a complete order for the garment. The first and second user selections may be received by the computer system through a user input interface of the computer system. The user input interface may be a touch screen interface of a display of the computer system, may be a mouse, may be a keyboard, or may be another user input interface. The order tool may include code that displays a preview image for the selected base template for the garment and the wear pattern for the garment. The selected base template and the wear pattern may be displayed as a combined image in the display and is representative of the garment after the garment is manufactured.

Before the order is received, while selections for the order are received, or after the order is received, the order tool receives a laser input file from a laser input file storage 1305. The laser input file storage 1305 can be housed in container 20 or can be connected to the select and order system by network 75.

At 1310, the order tool transfers a base template file and a laser input file to the computer controlled laser system 65. The base template file includes information that identifies the garment selected by the customer. The information that identifies the select garment can be displayed to an operator of the computer-controlled laser system via a display of the computer-controlled laser system or other notification system in container 10. The laser input file includes laser information for a predetermined design, a custom design, or both selected by the customer using the order tool. In an embodiment, the order tool or other tool stored and operable on the computer system includes code that generates the laser input file that is representative of the selected base template and the selected wear pattern. The laser input file may be generated from an image file for the wear pattern or other file or generated from an image file for the wear pattern and the base template file. In an embodiment, the order tool or other tool stored and operable on the computer system includes code that retrieves the laser input file from memory for transfer to computer controlled laser system. The base template file, the laser input file, or both may be stored in a memory of the computer-controlled laser system. In an implementation, the laser input file information for the wear pattern. In an implementation the laser input includes information for the wear pattern and the base template for a selected garment.

In an alternative implementation at 1310, the computer-controlled laser system retrieves the base template file, the laser input file, or both from a memory, such as a database of base template files, a database of laser input files, or both. The computer controlled laser system may retrieve the base template file, the laser input file, or both based on one or more identifiers for the base template file, the laser input file, or both that may be received from the computer system. A computer of the computer-controlled laser system may include any of the computer devices shown and described and may include any of the memories of the described computer devices to store the laser input file, the base template file, or both.

At 1315, the order tool transfers a laser input file with a design to the computer controlled laser system. A base template inventory 1320 provides the base templates of garments to the computer controlled laser system.

At 1325, a garment matching the customer selection is placed in a location for laser finishing, such as on a rack or on a table. In an implementation, the garment is a pair of jeans and the rack includes two inserts that extend into the legs of the jeans. The rack can hold the legs relatively flat for laser finishing.

Alternatively, when the garment is placed on a table for laser finishing, the table can include an outline in which the garment is to be placed so that the laser finishes the garment with the wear pattern in a desired and intended location on the garment. That is, the garment is registered with the outline in a predetermined orientation and location for laser finishing.

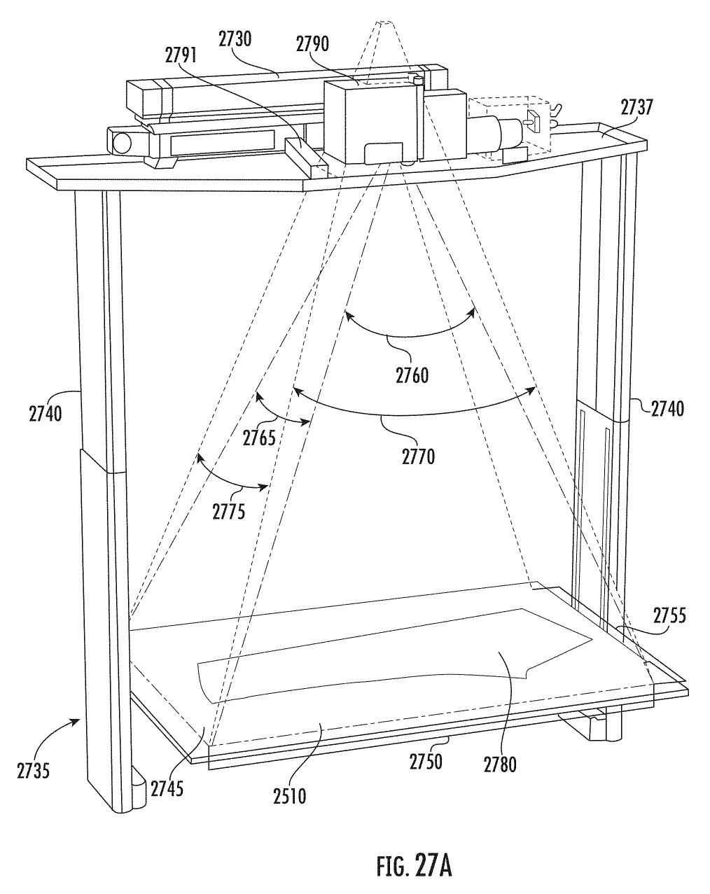

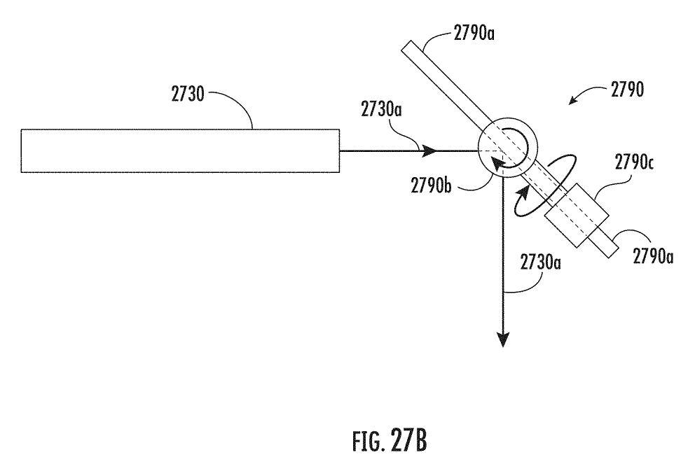

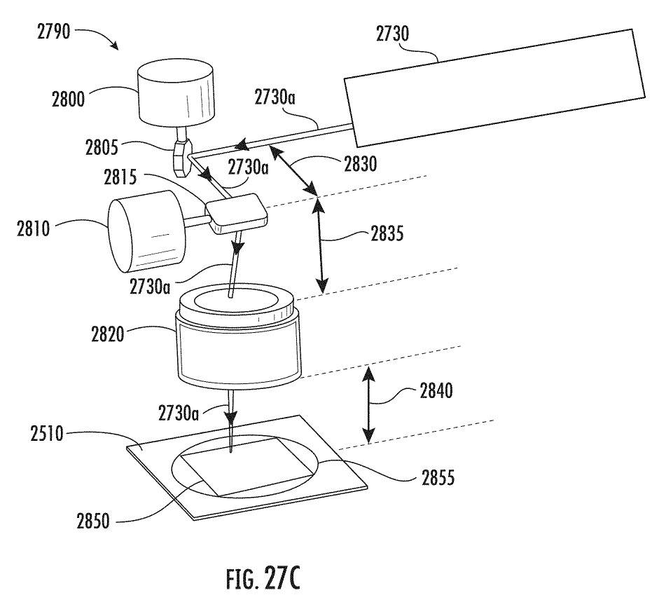

In an implementation, the computer controlled laser system scans the garment on the table to determine a location of the garment on the table (e.g., jeans folded lengthwise on the table). The laser system may include a camera 2791 (shown in FIG. 27A) that collects one or more images of the garment on the table. The one or more images collected by the camera may be analyzed by the camera, the camera in combination with the computer of the laser system, or the computer of the laser system to determine the location of the garment on the table. The camera, computer, or both may operate as an artificial vision system to determine the location of the garment on the table.

The computer may display the position of the garment on the table or may display the location at which the pattern will be laser formed on the garment by the laser based on the location of the garment of the table. If the pattern to be formed and displayed on the display is not positioned on the garment at a predetermined position on the garment based on the location of the garment on the table, the computer may move the position of pattern to be formed on the garment.

The computer may display the garment on the display with the pattern at the predetermined position on the garment after the computer moves the position of the pattern to be formed on the garment. In an implementation, a computer operator may move the position of the pattern to be formed on the garment using the computer. The operator may use a mouse, a keyboard, or other device to move the pattern displayed by the computer to the desired location of the pattern on the garment. In an implementation, an operator may physically move the garment so that the pattern is positioned on the garment at the predetermined location. The camera may collect image information for the new location of the garment on the table and the camera, computer, or both may determine whether the garment is appropriately located so that the pattern may be formed on the garment at the predetermined location.

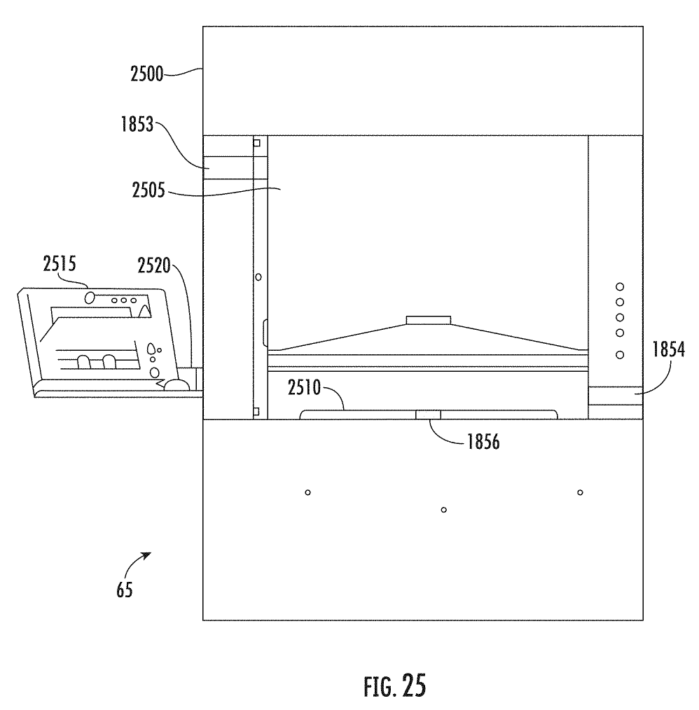

In an implementation, the table includes one or more light sources 1856 (shown in FIG. 25). The light source may be diode light source, such as a red diode. The diode directs light upward from the table and indicates generally where the laser beam will strike the table and garment. The light source operates as an indicator of where an operator is to place a garment on the table so that the pattern is formed at the predetermined location on the garment. In an implementation, the light source should be covered by the garment when the garment is appropriately located on the table to the pattern to be formed on the garment at the predetermined location.

After the garment is appropriately positioned, the laser controlled by a computer system of the computer-controlled laser system uses the laser input file to control the laser to laser finish the garment by laser forming a laser wear pattern in the garment. The wear pattern is formed on an outer surface of the garment, in an implementation. The wear pattern is formed on an inner surface of the garment, in another implementation. The wear pattern matches the preset design, the custom design, or both.

After laser processing, the garment is moved from container 20 to container 25 where postlaser processing is performed. The garment can be moved across the deck linking the two containers, moved across a conveyer on the deck, or others. In an implementation, the garment is tagged with a tag that identifies the garment as being ordered by the customer. The tag can be an RFID tag, a tag with text (e.g., printed text, handwritten text, or both), a bar code, one or more symbols (e.g., printed symbols, handwritten symbols, or both), or others. Text on the tag may include the customer's name, e-mail address, phone number, other identifier, or any combination of these.

At 1330, the garment is washed in a clothes washer that is located in container 25. This wash cleans and removes any residue caused by the laser, such as removing any charring (which would appear as brown, yellow, or slightly burning), removing ablated material (ablated fiber fragments) that remains on the garment, or both. The temperature of the wash water during the washing cycle may be constant or may be varied. In an implementation, the temperature of the wash water is between approximately 30 degrees Celsius and approximately 90 degrees Celsius (e.g., approximately 40 degrees Celsius) during the wash cycle. The length of time of the wash cycle may be set according to the particular garments being washed. In an implementation, the wash cycle time is between approximately 45 minutes and approximately 65 minutes (e.g., approximately 52 minutes) for washing jeans. In an implementation, the temperature of the airflow in the dyer is between approximately 30 degrees Celsius and approximately 90 degrees Celsius (e.g., approximately 60 degrees Celsius) and the dryer is operated for a drying cycle between approximately 30 minutes and approximately 60 minutes (e.g., approximately 45 minutes), such as for drying jeans. Other drying temperatures and drying times can be used for other types of garments.

The clothes washer, dryers, or both may be operated in a time stagger manner so that batches of garments may be delivered within times that are less than the washing times and drying times. For example, if the washing time for one washer is 60 minutes, then for three washer, washing cycles can be started every 20 minutes (e.g., staggered start and thus staggered stop times) so that batches garment are completed washing every 20 minutes. The start and stop times of the dryer cycles may be similarly staggered based on the length of time of the drying cycles so that batches garment are completed drying in a time staggered manner.

In an implementation, the wash water used by the clothes washer is transferred to a grey water storage tank, and from the grey water storage tank, the wash water is transferred to a water recycling system 1335. A drain of the sink is also connected to the water recycling system for recycling water used in the sink. The water recycling system may include a tank that holds the water for cleaning. The water recycling system cleans the wash water and sink drainage and returns the cleaned water to the clothes washer for reuse or sends the water to the clean water storage tank (e.g., 20-liter tank) for later use by the clothes washer. The water recycling system can be activated via user activation using one of the computer systems of center 10, or the water recycling system can be activated by a detection system in the gray water storage tank that detects when a predetermined amount of gray water has accumulated. The clothes washer, water recycling system, and storage tank is a closed system where water is not lost. The water recycle system is configured to remove soap, fabric softener, dye, tint material, bits of fabric, or other contaminants from the water. After the water is cleaned, the cleaned water is used by the clothes washer to wash another load of garments.

Subsequent to washing, the garment is transferred from the clothes washer to a clothes dryer at 1340. The clothes dryer dries the wet garment. Water is lost from the clothes dryers during the drying process. For example, one or more kilograms of water may be lost from the clothes dryers per day of operation. Therefore, a self-contained mobile finishing center having a water storage tank that stores 20 liters of water, for example, stores and supplies enough water for the center to operate for a week or longer (e.g., 7-100 days, such as 40 days, 50 days, 60 days, 70 days, 80 days, 90 days, or other number of days) without connecting to an external water source to replenish the water in the water storage tank. That is, with the loss of approximately one kilogram of water by the clothes dryers per day, the clothes washers can continue to be supplied with a sufficient amount of water from the water recycle system and water tank to operate for a week or longer without connecting to an external water source. As such, the center uses water in an efficient manner with little loss.

In an implementation, additional finishing is performed on the garment, which can include tinting, softening, ironing, or fixing, to complete finishing and thus finalizing the application of the wear pattern of the design to the garment. Tinting, softening, or both can be performed in one of the washing machines. The washed and dried garment is then a finished garment, at 1345. The pattern (e.g., wear pattern) on the dried garment has the appearance of the preview image displayed on the display of the order system that a customer may have viewed when ordering the garment. At 1350, the garment is ready for pickup by the customer. At pickup, the tag applied to the garment that identifies the custom can be at pickup to ensure the correct customer receives their custom finished garment. After identification of the customer, the tag can be removed from the garment. Thereafter, the garment is ready for wear by the customer with the wear pattern formed on the garment by the laser.

During laser finishing at 1330, the laser removes a selected amount of the surface of the indigo dyed yarn (e.g., blue color) of a garment to reveal a lighter color (e.g., white color) of the inner core of a ring-dyed yarn. The more of the indigo dyed material that is removed, the lighter the color (e.g., lighter shade of blue) of the garment will be. The more of the indigo dyed material that remains, the darker the color (e.g., deeper shade of blue) of the garment will be. The laser can be controlled precisely to remove a desired amount of material to achieve a desired shade of blue in a desired place or position on the material.

With laser finishing, a finish can be applied (e.g., printed, burned, ablated, or a combination of these via the laser) onto apparel (e.g., jeans and denim garments) that will appear similar to or indistinguishable from a finish obtained using traditional processing techniques (e.g., dry abrasion, wet processing, and oxidation, such as via chemical bleaching, ozone bleaching, or others). Laser finishing of apparel is less costly and is faster than traditional finishing techniques and has reduced environmental impact (e.g., eliminating the use of harsh chemical agents and reducing water waste).

FIGS. 14-17 show how the laser alters the color of ring-dyed yarn. FIG. 14 shows a ring dyed yarn fiber 1413 where an outer ring 1418 of the yarn is indigo dyed, green dyed, red dyed, yellow dyed, or other color and the fiber core 1422 of the yarn is white, a lighter shade of the color of the ring fibers (e.g., a lighter shade of indigo), or a color other then the outer ring of yarn (e.g., dark or light yellow).

A length of time between when an order is received for a garment and when the garment is laser finished and postlaser processed, is relatively short. The time difference can be 15, 20, 25, 30, 40, 45, 50, 55, 60, 65, 70, 75, 80, 85, 90, 95, or 100 minutes or other relatively short time length. As such, a garment can be ordered, laser finished, and postlaser processed during an event. Such short processing time is facilitated by locating the containers (which contain all of the equipment necessary for receiving a garment order and filling the order) adjacent to one another. Further, such short processing time creates excitement and anticipation for customers for receiving a custom ordered garment (e.g., jeans) at an event (e.g., sports event) where such a customer order and fulfillment of the order was previously not possible.

FIG. 14 shows a laser beam 1407 striking ring-dyed yarn fiber 1413 having indigo-dyed fibers in outer ring 1418 and white core fibers 1422 inside the outer ring in the core of the fiber. The laser removes a portion or all of the dyed fibers, which can be by ablation, vaporizing, burning, or otherwise destroying the cotton fiber via heat or high temperature that the laser beam causes.

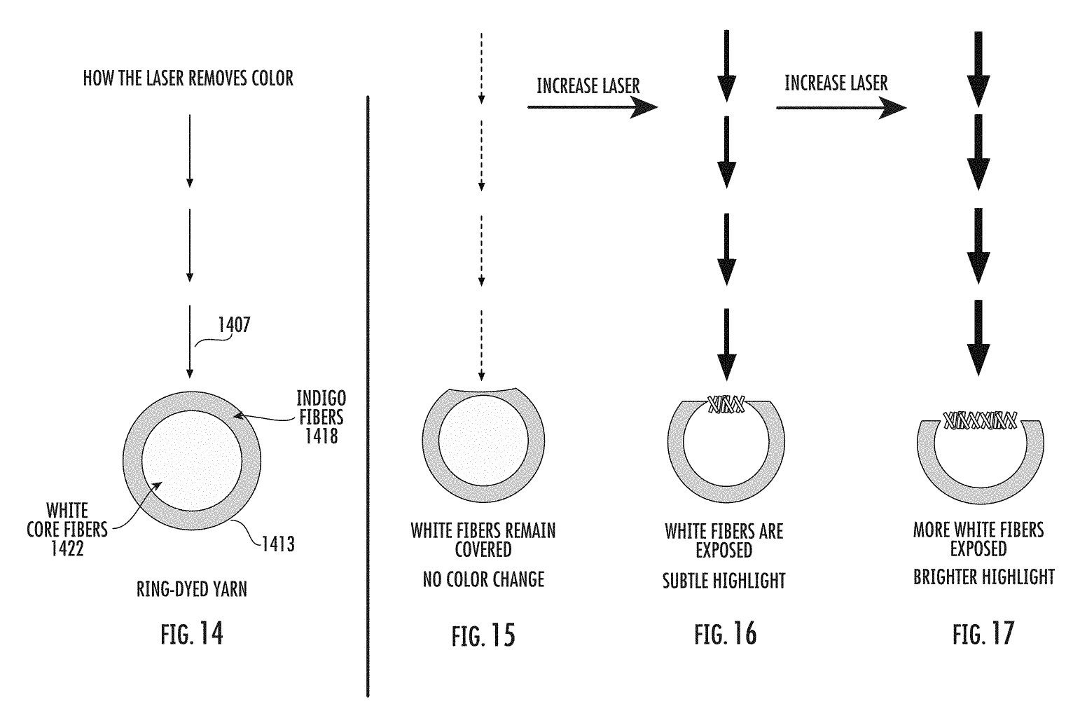

FIG. 15 shows the laser using a first power level setting or first exposure time setting, or a combination of these, to remove a portion of the dyed fibers of the outer ring, but not revealing any of the white core fibers. That is, the undyed fibers of the core remain covered and there is no color change of the ring fiber. The power level setting or the first exposure time

FIG. 16 shows the laser using a second power level setting or second exposure time setting, or a combination of these, to remove more of the dyed fibers than in FIG. 15. The second power level is greater than the first power level, or the second exposure time setting is greater than the first exposure time setting, or a combination of these. The result is some of the undyed fibers of the fiber core are revealed where the overlying ring fibers are removed. Thus, there is a color change of the ring-fiber with subtle highlighting.

FIG. 17 shows the laser using a third power level setting or third exposure time setting, or a combination of these, to remove even more of the dyed fibers of the ring than in FIG. 16. The third power level is greater than the second power level, or the third exposure time setting is greater than the second exposure time setting, or a combination of these. The result is more of the undyed fibers are revealed where more of the overlying ring fibers are removed. There is a color change of the ring fiber with brighter highlighting.

The laser strikes pixel points on a garment where the pixel points correspond to the information in the laser input file. At each pixel point, the power lever setting (e.g., leaser beam intensity), the first exposure time setting (e.g., burning or ablation time), or both may be varied based on the laser input file.

In an implementation, the fabric of a garment is prepared for laser finishing by the laser. The preparation may be referred to as a base preparation, and can include a prelaser wash. Washing prior to laser finishing helps improves the results of the laser finishing process. After laser finishing, there can be a postlaser wash as described above. This wash can clean or remove any residue caused by the laser, such as removing any charring (which would appear as brown or slightly burning), removing ablated material that remains on the garment, or both. There can be additional finishing, which may be including tinting, softening, or fixing, to complete finishing and thus applying the wear pattern of the design to the garment.

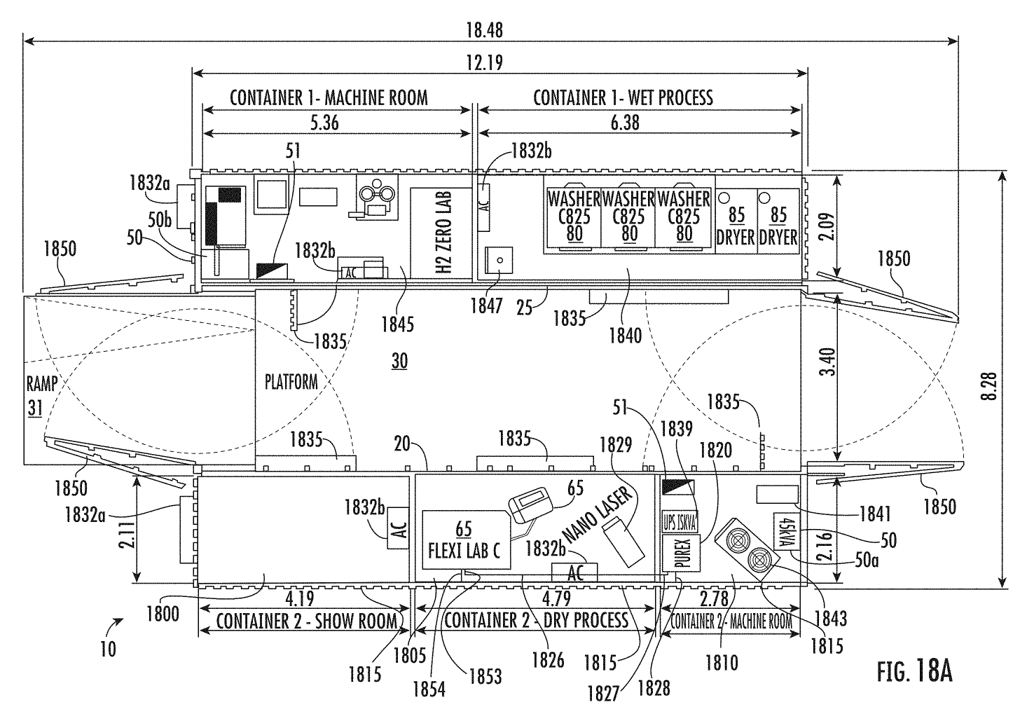

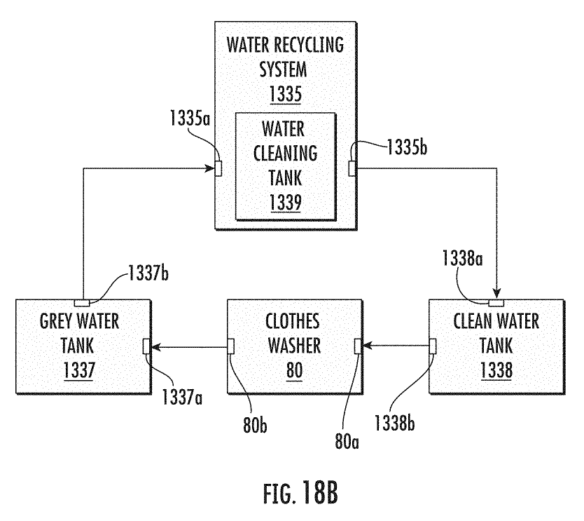

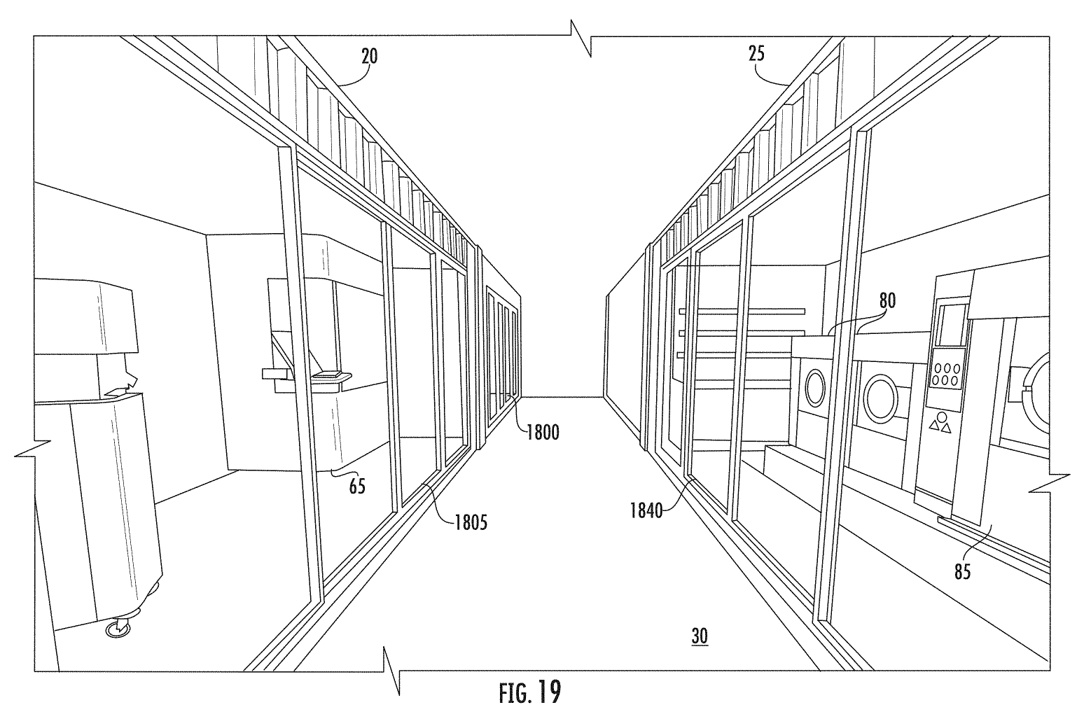

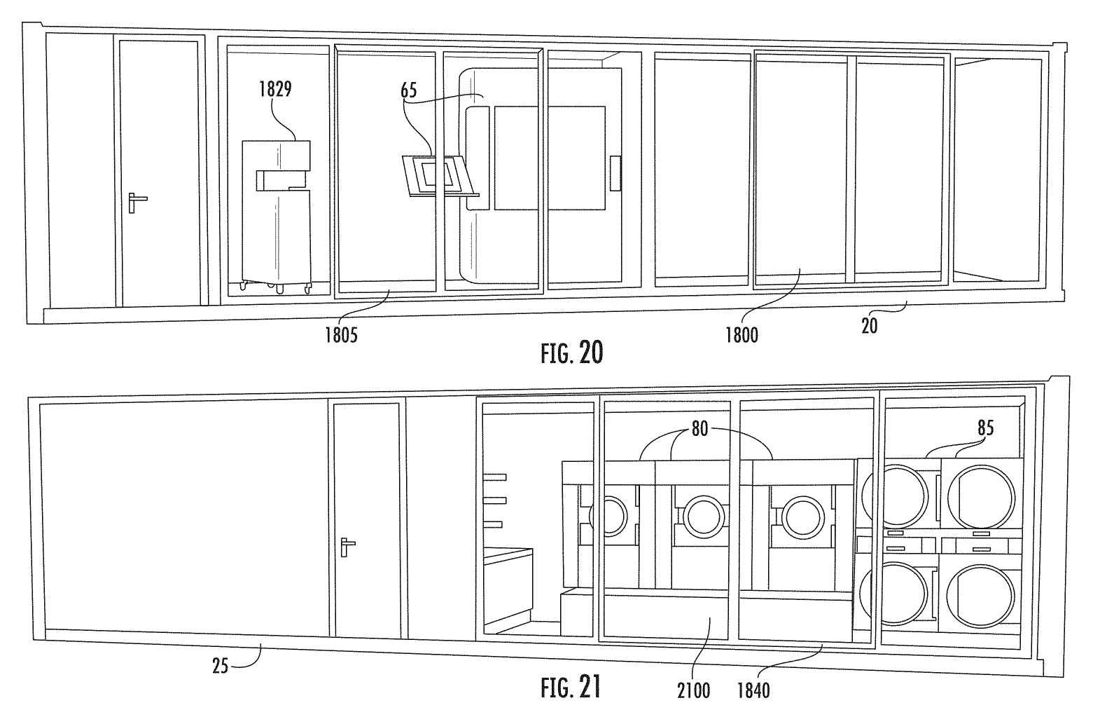

FIG. 18A shows the self-contained mobile finishing center 10, in an implementation. Lengths listed on FIG. 18A are in meters. Containers 20 and 25 are connected by deck 30. The deck is connected to ramp 31. The ramp can have a relatively low angle (e.g., 8, 9, 10, 11, 12, 13, 14, or other degrees) that angles upward from the ground to an upper surface of the deck. The ramp can be separable from the deck for storage or can be hinge connected to the deck where the ramp can hinge rotate onto the upper side of the deck or to the underside of the deck. Center 10 can include an awning (not shown) that covers the deck, the ramp, or both. The awning can be connected to containers 20 and 25 and shield the deck from rain and sun. The awning can be removable from the containers or be adapted to roll onto one of the containers via an awning roller system.

The ramp can extend past leading sides of the containers to the front side of the deck. The center can therefore, have a width of 8.28 meters or other widths. The center can have an overall length of 18.48 meters from the end of the ramp to the tip of door 1850 in an open configuration.

The containers are connected to an electrical supply 50, which supplies power to the containers. The electrical panel 50a of container 20 that connects to electrical source 50 can be a 45 kilovolt-ampere (kVA) electrical power source and the electrical panel 50b of container 25 that connects electrical source 50 to can be a 150 kilovolt-ampere electrical power source. The electrical panels 50a and 50b can provide other electrical power amounts in alternative implementations, such as if center 10 includes more or fewer clothes washer and dryers or more computer-controlled laser systems. At least container 25 can be connected to an external water supply 55 (e.g., a municipal water supply).

Container 20 includes a showroom 1800, a dry processing room 1805, and a machine room 1810. The showroom can be 4.19 meters long or other lengths and 2.11 meters wide or other widths. The dry processing room can be 4.79 meters long or other lengths and 2.11 meters wide or other widths. The machine room can be 2.70 meters long or other lengths and 2.11 meters wide or other widths. One or both of the showroom and the processing room includes a window 1815. Container 20 includes one or more doors 1835, such as sliding glass door or others.

The showroom is where customers or staff can use the select and order system 60 or view sample garments (e.g., jeans) that are displayed in the showroom. The showroom can include a fitting room where customers can try on garments before selecting a size of garment for purchase. The showroom can include one or more sewing machines for making alterations to garments, such as hemming the lengths of pant legs ofj eans.

The dry processing room includes the computer controlled laser system 65 (labeled flexi lab C in FIG. 18A). The dry processing room can include one or more shock absorbing systems that inhibit the transfer of physical shock to the laser of the laser system. For example, the raised floor of the dry process room can be a shock absorbing floor and the laser system can include one or more shock absorbing devices to inhibit the transfer of physical shocks to the laser. The shock absorbing floor can inhibit or prevent the transfer of the shock from footsteps to the laser and other shock absorbers can inhibit the transfer of shocks as the laser is put into a place of use or during transportation. Thus, realignment of the laser can be limited or eliminated after center 10 is moved by truck or rail to new locations.

The machine room includes an air purifier machine 1820 (labeled purex in FIG. 18A) that is connected to laser 65 (e.g., Flexi Lab C by Jeanolgia) via one or more ducts 1826. The air purifier machine is sometimes referred to as an exhaust device. The ducts run from an exhaust input 1827 of the air purifier machine (e.g., an exhaust input of the air purifier machine) to an exhaust output 1853 of the flexi lab c under a raised floor of container 25. Flexi lab c may include an exhaust input 1854 that allows air to enter the flexi lab c. The exhaust input may extend through a opening in the first container to an exterior of the first container. Air may pass from the exhaust input of the flexi lab c, through a chamber of the flexi lab c that houses a garment during laser finishing, and exit the exhaust output of the flexi lab c into the exhaust system thereby removing particulate matter from the flexi lab c that is generated during laser finishing.

The raised floor can be 64 millimeters (or other height) above the floor of the container. The top of the raised floor and the height of the top surface of the deck can be 775 millimeters above the ground. In an implementation, the containers remain on the trailers for use. Electrical lines, water lines, air conditioning ducts, and other lines and air vents can be routed under the raised floor. The air purifier machine collects the air from laser 65 and filters the air to remove particles and debris from the air. That is, during laser finishing of the garment, smoke and other particulate matter are created by the laser striking the garment. This debris is collected to keep the dry processing room clean and to prevent staff in the room from inhaling the debris. The air purifier machine includes an exhaust output 1828 that can extend from the air purifier machine on the interior of the first container to an exterior of the first container. The sidewall, roof, floor, or any combination of these elements includes an opening through which the exhaust port can extend to vent air from the laser to an exterior of the first container.

The machine room includes an air compressor 1841. Air compressor 1841 is connected to one or more hoses or pipes that direct compressed air to the laser. In an implementation, the laser uses 6.5 bars of air pressure or greater for operation. Thus, the air compressor is adapted to generate at least 6.5 bars of pressure on air directed into the hoses or pipes that connect the air compressor to the laser. The hoses or pipes can be routed through the raised floor of container 20.

In an implementation, the dry process room includes a second laser system 1829 (e.g., a nanolaser system). The second laser system is adapted for laser finishing letting or designs (e.g., images, graphics, or other designs) onto a garment. The second laser system emits a laser beam with a relatively small diameter, such as 0.2 millimeters. In other implementations, the diameter of the laser beam is approximately 1 millimeters or less. Thus, the second laser can form relatively fine letters and designs on garments. The letters or designs may not be included in the laser file used by computer controlled laser system 65 for laser forming the wear pattern on a garment. The letters and designs may be user selectable via the select and order system. A second laser file for the letters, designs, or both may be transmitted from the select and order system to the second laser system via a network link. The second laser file may be a bitmap file, a proprietary file type, or file type. In some implementations, the second laser can be used to laser finish garments when the laser of computer-controlled laser system 65 is not used to laser finish a wear pattern onto a garment. Also, the second laser can be used before or after the laser of system 65 is used.

In an implementation, the laser of the computer controlled laser system scans the garment on the table to determine a location of the garment. More specifically, the computer-controlled laser system can include a light (e.g., IR, visible light, or UV) collection device (e.g., a camera) that collects light from the laser after reflection from the table, garment, or both to determine the location of the garment of the table. Thus, once the location of the garment is known, the laser can apply the laser finish on the garment at the intended location on the garment. After the garment is appropriately positioned, the laser controlled by a computer system of the computer-controlled laser system, controls the laser to laser finish the garment forming a laser wear pattern in the garment. The wear pattern matches the preset design, the custom design, or both.

The laser of the computer controlled laser system, the nanolaser, or both can be cooled lasers. Container 20 can include a cooling system 1843 that connects to one or both of the lasers via one or more coolant ducts that extend under the raised floor of the container from the cooling system to the lasers. The cooling system can supply a cooling fluid (e.g., liquid or gas) to one or both of the lasers to cool the laser so that the laser operate at predetermined temperatures to stabilize the lasers and extend the longevity of the lasers. In an implementation, the cooling fluid is water. The temperature of the cooling liquid may be between approximately 20 degrees centigrade and approximately 28 degrees centigrade, such as approximately 24 degrees centigrade.

The machine room includes one or more electrical panels 1834 that receive electrical power from the power supply and distribute the power through container 20. The machine lab also includes an air extractor 1837. The machine room includes an uninterruptible power supply (UPS) 1839. The UPS is connected to the electrical panel so that a battery backup of the UPS can remained charged. If electrical power from power supply 50 fails, the UPS can continue to supply power to container 20 for a period of time from a battery backup.

The UPS also conditions power from power supply 50 so that AC power supplied to the components of container 20 will be at a desired or expected voltage (e.g., 110, 120, 220, 230, or other voltage) at a desired or expected frequency (60, 50, or other frequency) having a desired or expected waveform (e.g., sine wave). This will help prevent damaging the equipment, including the laser. Thus, the laser of the laser system, which can be costly to replace, is protected from voltage spikes (e.g., overvoltage conditions) or voltage drops (e.g., undervoltage conditions) from power supply 50 and receives a known voltage at a known frequency so that the laser operates predictably.

In an implementation, the laser of the computer controlled laser system uses 6-7 kilowatts (e.g., 6.5 kilowatts) of electrical power for proper operation. The laser generates a beam that has 230-270 watts (e.g., 250 watts) of power. In an implementation, the laser generates a continuous laser beam. In an implementation, the laser generates a pulsed laser beam. The laser can be an infrared laser, an ultraviolet laser, a visible light laser, or other type of laser. The laser can be a Rofin UK SR25i CO2 laser (e.g., a carbon dioxide class IV laser) with an intelliSCAN head 30 of Scanlab A.G. The laser may emit ultraviolet light centered at centered at 9.4 micrometers, 10.6 micrometers, or both. The laser beam can be a single beam or can be split into multiple beams. The laser can have varioSCAN 40 flex T89 optics of Scanlab. The container includes an electrical panel 51 that power supply 50 and UPS 1839 connect to. The electrical panel can distribute power from the power supply to the UPS, directly supply power to power outlets in the container, or both. The electrical panel can be a fused panel with one or more fuses to protect the container from large current surges. Power distribution lines that connect the power supply, electrical panel, UPS, computers, laser, outlets (e.g., located along the walls, ceiling, or floor of the container), and other electrical devices are located under the raised floor of the container.

Container 20 includes an air conditioner (AC) unit 1832a and one or more AC vents 1832b. The AC unit is mounted to the external side of an end wall of container 20. The end wall is a wall of the showroom. The AC unit can be mounted to other location, such as on top of the container. In an implementation, the showroom, the dry processing room, and the machine room each include an AC vent. The equipment (e.g., the laser system) in the container is adapted to be operated at a set temperature of 28 degrees C. In an implementation, the laser is adapted to operate at other temperatures, such as 20-30 degrees C. Therefore, the laser and other equipment operate in a predictable manner that extends the longevity of the equipment and prevents the laser and other equipment from being damaged due to operation outside of a desired and known temperature range. In an implementation, the temperature of each room is monitored and independently controlled to keep each room at a desired and known temperature, such as at different optimal temperatures for the operation of the particular equipment in the different rooms.

Container 25 includes a wet process room 1840 and a machine room 1845. The wet process room can be 6.38 meters long or other lengths and can be 2.11 meters wide or other widths. The machine room can be 5.36 meters long or other lengths and can be 2.11 meters wide or other widths.

One or both of the showroom and the laser processing room includes a window. One or both of the wet process room and the machine room includes a window. Containers 20 and 25 includes one or more doors 1835, such as sliding door, sliding glass doors or others. The doors of the containers can be across from each other or face each other. With the doors across from each other movement between the containers is efficient moving garments between the containers.

The wet process room can connected to the water supply and includes at least one clothes washer (e.g., 3 washers) 80 and at least one clothes dryer (e.g., 4 dryers) 85. The clothes washers can be 1080 millimeters tall, 2000 millimeters wide, and 1800 millimeters deep, or other dimensions. The washers can be in a row and can be adjacent to the dryers. The clothes dryers can be “stacked” clothes dryers where one dyer is located on top of another clothes dryer. A first dryer can be stacked on a second dryer. A third dryer can be stacked on a fourth dryer. The two stacks can be adjacent with the first and third dryers forming a row and the second and fourth dryers forming a row. The clothes dryers can be 1937 millimeters high, 800 millimeters wide, and 1086 millimeters deep. The wet process room includes a sink 1847. The wet process room can include storage space for storing chemicals, such as determent used by the clothes washers for washing garments.

The wet process room or the machine room or includes water recycle system 1335, which recycles water used by the clothes washers as described above with respect to FIG. 13.

FIG. 18B shows one of the washers 80 connected with the water recycling system 1335, in an implementation. The washer and water recycling system may also be connected with a grey water tank 1337 and a clean water tank 1338. The washer includes an outlet port 80b that is connected to an inlet port 1337a of the grey water tank. The grey water tank includes an outlet port 1337b that is connected to an inlet port 1335a of the water recycling system. The water recycling system includes an outlet port 1335b that is connected to an inlet port 1338a of the clean water tank. The clean water tank includes an outlet port 1338b that is connected to an inlet port 80a of the washer. The various inlet and outlet ports may include valves to control the flow of water. The various inlet and outlet ports may be connected by hoses, pipes, or other conduit material that is adapted to transport water. The inlet port 1335a and the outlet port 1335b of the water recycling system may form a portion of a water cleaning tank 1339 of the water recycling system. In an implementation, water cleaning tank 1339 includes a number of tanks (e.g., three water tanks) that may be used for different types of cleaning of the water, such as filtration (e.g., in a water filtration tank), membrane filtration (e.g., in a membrane filtration tank), chemical cleaning (in a chemical cleaning tank), or others. Chemical cleaners used to clean water in a chemical cleaning tank can includes oxidizers, such as bleach, ozone, or other chemicals. In an implementation, light, such as ultraviolet light, is used in one or more of the tanks for cleaning water from the washers. Each of these tanks of the water recycling system may include an input port and an output port that are connected by pipes, hoses, or other conduit for water transfer between these tanks, the grey water tank, and the clean water tank.

In an implementation, the washer and the water recycling system are connected with the clean water tank. The washer's outlet port may connected to the inlet port of the water recycling system. The water recycling system's outlet port may connected to the inlet port of the clean water tank. The clean water tank's outlet port may connected to the inlet port of the washer. The connected inlet ports and outlet ports may be connected by pipes, hoses, or other conduit for water transfer between the ports.

In an implementation, the washer and the water recycling system are connected with the grey water tank. The washer's outlet port is connected to the inlet port of the grey water tank. The grey water tank's outlet port is connected to the inlet port of the water recycling system. The water recycling system's outlet port is connected to the inlet port of the washer. The connected inlet ports and outlet ports may be connected by pipes, hoses, or other conduit for water transfer between the ports.

Container 25 includes one or more AC units 1830a and one or more AC vents 1830b. Container 25 includes an electrical panel 51 that is connected to power supply 50. The electrical panel can distribute power from the power supply to various equipment in the container and to various outlets in the container. The outlets can be located along the walls, ceiling, or floor of the container. The container can include a UPS (not shown) that connects to the electrical panel.

Container 25 includes a raised floor. The raised floor can be 64 millimeters (or other height) above the floor of the container. Electrical lines, water lines, air conditioning ducts, and other lines and air vents can be routed under the raised floor.

In an implementation, each container 20 and 25 includes one or more doors 1850 (e.g., two doors) that open and close to expose and cover an entire side of each of the containers. The doors can be steel (e.g., corrugated steel) or other material. The doors can be hinged doors that hinge connect to the containers and can be hinge opened and hinge closed. Alternatively, the doors can be roller doors that can roll up or down, such as up onto the tops of the containers. Each door can include two sections that are hinge connected such that each door can be “folded.” In an implementation, the doors are removable from their respective containers.

Doors 1850 open to expose the sides of the containers that include doors 1835. With doors 1850 and 1835 open, the containers have an open and inviting appearance that invites customers into the containers to purchase garments and view the processed used to laser finish the garments. The customers can view the laser finishing and the water saving processes implemented by the containers. Customers can also witness the lack of use of oxidizing chemicals (e.g., bleach, ozone, or other chemicals) used in the laser finishing process and understand that their purchase is limiting the disbursement of chemicals into the environment.

FIG. 19 shows a view of containers 20 and 25 from a central section of deck 30. Specifically, FIG. 19 the containers with doors 1850 opened and shows an exterior view of showroom 1800 and dry processing room 1805 where the computer controlled laser system 65 is located. FIG. 19 further shows the clothes washer 80 and dryers 85 in the wet process room 1840. In an implementation, the showroom, dry process room, and wet process room have windows, such as glass doors, that face towards the deck.

FIG. 20 shows a side view of container 20, showroom 1800, and dry process room 1805 with the computer controlled laser system 65 and nanolaser 1829 in the dry process room. The windows (e.g., window of the sliding glass doors and other windows) of container 20 allow for viewing, access, or both of the interiors of these rooms, such as interior views of the laser device or other equipment in container 20.

FIG. 21 shows a side view of container 25 and shows the wet process room 1840 with the clothes washers 80 and dryers 85 in the room. The dryers are shown in a stacked configuration where the four dryers in the room are configured in stacks of two dyers each. Windows (e.g., windows of the sliding glass doors and other windows) of container 25 allow for viewing, access, or both of the interior of the wet process room. In an implementation, the clothes washers are located on a platform 2100. In addition to routing space under the raised floor of container 25, the platform provides additional space under the washer for routing water lines, drain lines, electrical wires, any combination of these elements, or other elements. The drain of each washer may drain into a single drain line under the platform to allow the water from the washer to be drained to the grey water storage tank 1337. The platform facilitates gravity draining the water from the washer. In an implementation, the water is not pumped from the washers to the grey water tank allowing for energy conservation. In an implementation, the platform, the raised floor that the platform is raised above, or both are vibration damped. The vibration damping isolates the vibration of the washers (e.g., during water extraction from garments) from other equipment in the container.

The height of the platform above a top surface of the raised floor of container 25 may be 25.4 centimeters (10 inches) or more, such as about 45.7 centimeters (18 inches). Not only does the platform provide additional room for routing under the platform, the platform also positions the doors of the clothes washers at a comfortable height for users to put garments into the washer and remove garments from the washer. The comfortable height of the doors provides that a user may not bend down or bend down by a relatively small amount to put garments into the washer and remove clothes from the washer.

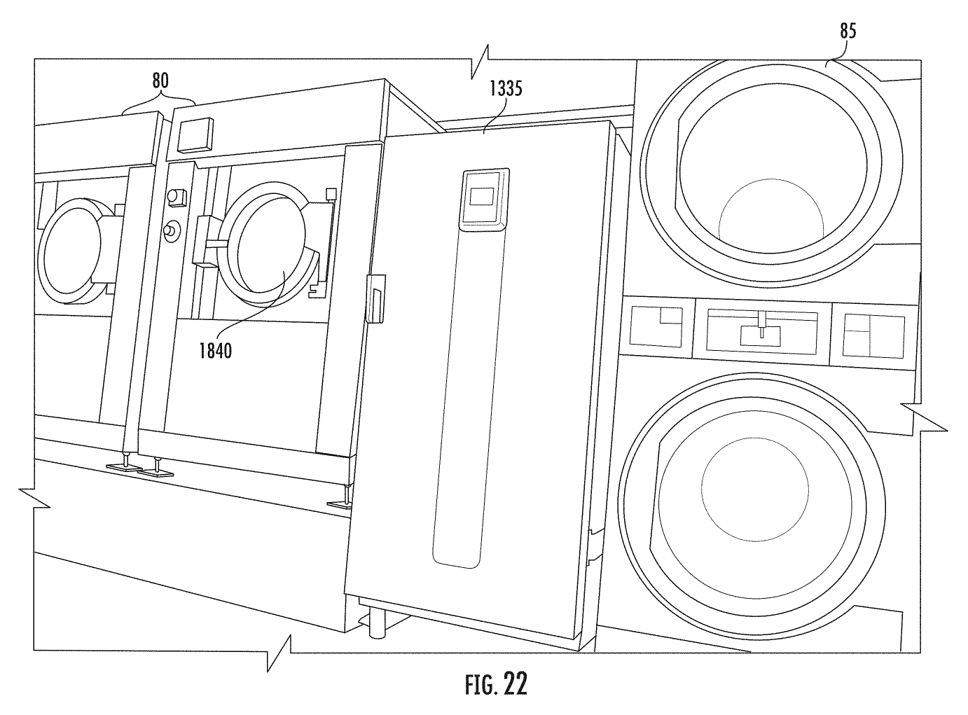

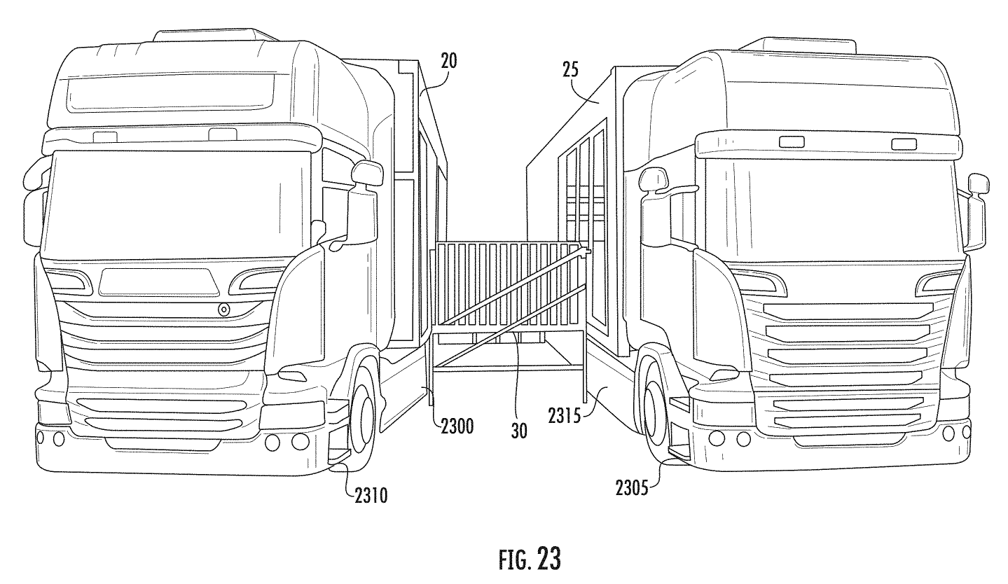

FIG. 22 shows an interior view of the wet process room 1840 with the clothes washers 80 and dryers 85 in the room. In an implementation, the wet process room includes water recycle system 1335. The washers can be vertical stacked, arranged horizontally adjacent, or both. The dryers can be vertical stacked, arranged horizontally adjacent, or both.

FIG. 23 shows containers 20 and 25 loaded on truck trailers 2300 and 2305 of trucks 2310 and 2315 adapted to transport the containers. The containers are connected by deck 30 located between the containers. In an implementation, the containers are removable from the trailers. The containers can be placed on the ground for use for processing garments (e.g., laser forming a wear pattern on a garment). The trucks and trailers can be driven away from a location where the trailers are place to create a spacious area near the containers. Thus, a pleasing and inviting environment is created near the containers with the trucks and trailers moved away. Subsequent to use, the containers can be placed back onto the trailers for transport. In an implementation, the containers remain on the trailers for use. Leaving the containers on the trailers facilitates relatively fast transportation and setup of the containers at a location and relatively fast removal of the containers from the location. In an implementation, the trucks remain connected to the trailers with the containers on the trailer during use.

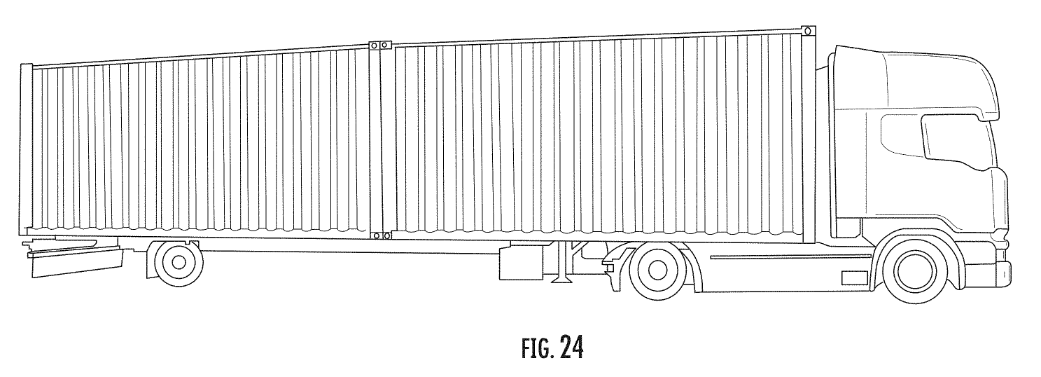

FIG. 24 shows a side view of one of the truck trailers and one of the trucks with one of the containers on the trailer. The container is 12.2 meters (40 feet) long but can be other lengths.

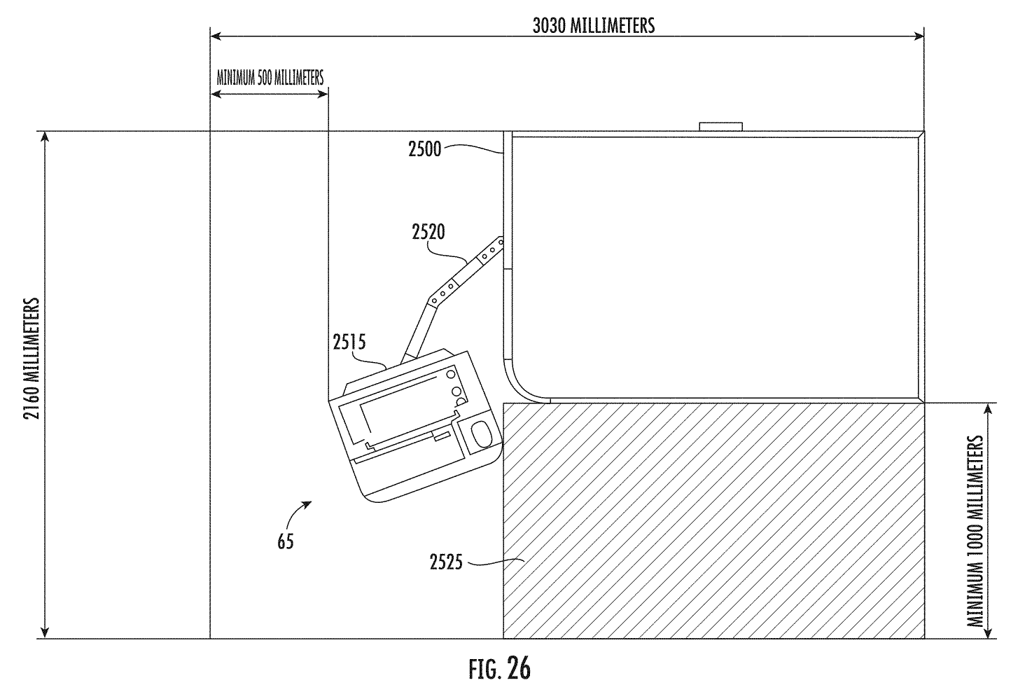

FIGS. 25-26 show a front view and a top view of a computer controlled laser system 65, in an implementation. Laser system 65 includes a cabinet 2500 that houses the laser of the laser system. The cabinet can metal, plastic, glass, organic material (e.g., carbon fiber), or any combination of these materials. The cabinet includes an open area 2505 that includes a table 2510. A door (e.g., a door with a window) can be connected to the cabinet where the door opens for staff access to the open area and closes when the laser is operating. The window can be adapted to block radiation, such as ultraviolet radiation, emitted by the laser but permit visible light to pass through the window so that the garment is visible. The table is adapted to support a garment for laser finishing by the laser. The table can include one or more registration marks (e.g., a garment shaped outline) that guide a user to place a garment in a predetermined location and orientation so that the laser applies the laser finish appropriately (e.g., laterally correct and rotationally correct) on the garment.

The cabinet includes the exhaust input 1854 and the exhaust output 1853. The exhaust input and the exhaust output are connected to the open area 2505 of the cabinet of the computer-controlled laser system. The exhaust input is adapted to allow air from outside of the chamber to flow into the chamber and the exhaust output is adapted to allow air from inside the chamber to flow out from the chamber. Thus, air entering the exhaust input can flow out from the exhaust output and can flow through the chamber.

The exhaust device 1820 may be adapted (e.g., via a fan) to draw air through the exhaust input, through the chamber, and through the exhaust output. In an embodiment, the chamber is pressurized (for example by the air compressor) to force air through exhaust input, the chamber, and out through the exhaust output. That is the exhaust device, the air compressor, or both may create an air pressure differential across the exhaust input and exhaust output to force air from the exhaust input (e.g., having relatively high pressure air), through the chamber, and out the exhaust output (e.g., having relatively lower pressure air than the relatively higher pressure air of the exhaust input).

A computer system 2515 (e.g., tablet computer, laptop computer, desktop computer, or others) of system 65 is connected to an exterior of cabinet 2500 via an articulating arm 2520. The articulating arm can move the computer system laterally, vertically, or both to a comfortable working location. In an alternative implementation, the computer system is located on a stand that can be rolled to different locations for use.

Cabinet 2500 has a height of 2443 millimeters, a width of 1740 millimeters, and a depth of 1400 millimeters. In an implementation, these lengths are smaller, for example, if the container is adapted to house multiple laser cabinets 2500. A working area around the cabinet can be approximately 2460 millimeters wide and approximately 1500 millimeters deep. In an implementation, the working area around the cabinet can be approximately 3030-2440 millimeters wide and approximately 1450-2160 millimeters deep, for example, if the container is adapted to house multiple laser cabinets 2500. A working area 2525 in front of the cabinet is 500-1200 minimum wide and 500-1000 millimeters deep. A minimum distance of computer system 2515 from a lateral side of the working area is a minimum of approximately 500 millimeters, so the computer system will not strike a wall of container 20 or strike other items.

The cabinet height allows for the cabinet to be positioned inside the container, which has a relatively small interior height (e.g., 2.6 meters or less, 2.6-2.2 meters). Other environments, such as a warehouse building (e.g., “brick and mortar” building), do not place such height constraints on laser system 65 where ceiling are relatively high, such as greater than 2.6 meters. The cabinet height can allow for an air space (e.g., a 30-70 millimeter tall space) above the cabinet and below the ceiling of the container for air circulation. The air space inhibits heat accumulation above the laser system while operating.

FIG. 27A shows a laser 2730 of laser system 65 that is located in cabinet 2500, in an implementation. The laser is supported by a frame 2735 that includes a shelf 2737, a table 2510, and sides 2740. The sides connect the top and bottom shelves. The laser is located on a top surface of the top shelf. An aperture or cutout in the top shelf allows the laser beam to travel downward to a garment positioned on the table for laser finishing. Camera 2791 may also be on a top surface of the top shelf. An aperture or cutout in the top shelf may allow the camera to view and collect images a garment positioned on the table for determining the location of the garment on the table for laser finishing. The location of the garment on the table allows for the wear pattern to be lasered onto an outer surface of the garment in a known location and known orientation.

In an implementation, the laser beam is directed downward into an approximately rectangular area 2745 of the table. The laser beam can be directed into areas having other shapes such as oval, elliptical, circular, rounded rectangle, square, polygonal, or others. Across a longitudinal length 2750 of the area that the laser beam is directed into, the laser beam is swept through a first angle 2760 of 47 degrees. In an implementation, the sweep angle is 42 degrees or greater, such as 42-49 degrees. In an implementation where table 2510 is rotated, the laser beam is swept through a first angle 2760 of 30 degrees. In an implementation, the sweep angle is 26.5 degrees or greater, such as 26.5-32 degrees. In an implementation, the sweep angle is 26 degrees or greater, such as 26-32 degrees.

Across a lateral length 2755 (transverse to and shorter than the longitudinal length) of the area that the laser beam is directed into, the laser beam is swept through a second angle 2765 of 30 degrees. In an implementation, the sweep angle is 26.5 degrees or greater, such as 26.5-32 degrees. In the implementation where table 2510 is rotated, the laser beam is swept through the second angle 2765 of 47 degrees. In an implementation, where the table is rotated, the sweep angle is 42 degrees or greater, such as 42-49 degrees. In an implementation, the first and second sweep angle are the same to form a square sweep area.

In a specific implementation, the laser is housed at a top of the cabinet. The table on which the garment that will be exposed to the laser is placed is about 1350 millimeters from a lens of the laser or a mirror of a galvanometric scanner (described below). The table is rectangular, about 1200 millimeters by about 900 millimeters. The laser beam can sweep across the table, from one side of the garment to the other. An angle 2760 of this sweep is about 47 degrees (e.g., 23.5 degrees on either side of center). In other implementations, the distance from the laser lens or mirror of the scanner to the table can vary, such as from 1300 millimeters to 1400 millimeters. Then the sweep angle of the laser can vary from about 42 degrees to about 49 degrees. In other implementations, such as for larger or longer garments, the sweep angle can be increased to 47 degrees or more. In other implementations, such as for shorter or smaller garments, the sweep angle can be decreased to about 47 degrees or less, such as about 42 degrees to 47 degrees. It may not be desirable to increase the sweep angle very greatly because the beam size will increase as the angle increases, especially at extreme angles from center.

The table length and width govern the size of the garment can be lasered. In an implementation, jeans are lasered one leg at a time, front and back. Thus, to completely finish one garment, the laser will scan four times, front left leg, front right leg, back left leg, and back right leg. In other implementations, the table width is wider (e.g., greater then 900 millimeters, such as about 1200 millimeters to have a square table). Then the laser will scan two times, front left and right legs at one time, and back left and right legs at one time.

In another specific implementation, the table on which the garment will be exposed to the laser is placed is about 1350 millimeters from the lens of the laser or the mirror of the galvanometric scanner. The laser beam can sweep across the table, from one side of the garment to the other. An angle 2765 of this sweep is about 30 degrees. In other implementations, the distance from the laser lens or the mirror to the table can vary, such as from 1300 millimeters to 1400 millimeters. Then the sweep angle of the laser can vary from about 25 degrees to about 35 degrees. In other implementations, such as for narrower or wider garments, the sweep angle can be increased to 35 degrees or more. In other implementations, such as for narrower garments, the sweep angle can be decreased to about 30 degrees or less, such as about 25 degrees to 30 degrees. It may not be desirable to increase the sweep angle very greatly because the beam size will increase as the angle increases.

Due to the height constraint inside container 20, the first angle 2760 and second angle 2765 are larger than a third angle 2770 and a fourth angle 2775, respectively, through which the beam is directed where height constraints for the laser do not exist, such as in a warehouse building with a relatively high ceiling, such as greater than 2.6 meters. The vertices of the third and fourth angle are above the laser of the laser system.

As shown in FIG. 27A, a pair of jeans is 2780 is folded lengthwise on the table. The jeans are arranged on the table so that a first side of a first pant leg is facing up on the table and the first side of the second pant leg is on the table and facing downward. In this arrangement, the first side of the first pant leg is laser finished. Thereafter, the jeans are turned over so that the first side of a second pant leg is facing up on the table and the first side of the first pant leg is on the table and facing downward. In this arrangement, the first side of the second pant leg is laser finished.

Thereafter, the jeans are folded lengthwise so that the first sides of the first and second pant legs face each other and so that a second side (opposite of the first side) of the first pant leg and a second side (opposite the first side) of the second pant leg are exposed and available for laser finishing. Then, then jeans are positioned on the table with the second side of the first pant leg facing up on the table and the second side of the second pant leg is on the table and facing downward. In this arrangement, the second side of the first pant leg is laser finished. Thereafter, the jeans are turned over so that the second side of a second pant leg is facing up on the table and the second side of the first pant leg is on the table and facing downward. In this arrangement, the second side of the second pant leg is laser finished.

Four different laser finishing scans of the jeans are performed to laser finish two sides of the two pant legs of a pair of jeans. Laser finishing with the jeans folded in half lengthwise on the laser finishing table provides that the jeans do not wrinkle during laser finishing and therefore further provides that the wear pattern is formed on the jeans in a desired and known location and orientation.

In an implementation, the table includes two registration patterns. A first registration pattern includes the crotch portions of the jeans facing a first direction (e.g., facing left on the table), and a second registration pattern include the crotch portion of the jeans facing in a second direction (e.g., facing right on the table). That is, the first and second directions are opposite positions.

Using the first registration pattern for registering the jeans to the first pattern, the first side of a first pant leg and the second side of the second pant leg, when facing up on the table, are located in a desired and known location and orientation on the table for laser finishing. Using the second registration pattern, the second side of a first pant leg and the first side of the second pant leg, when facing up on the table, are located in a desired and known location and orientation on the table for laser finishing.

In an implementation, the table includes a number of registration outlines for different sizes of garments. In another implementation, jeans are laser finished in an unfolded arrangement on the table.

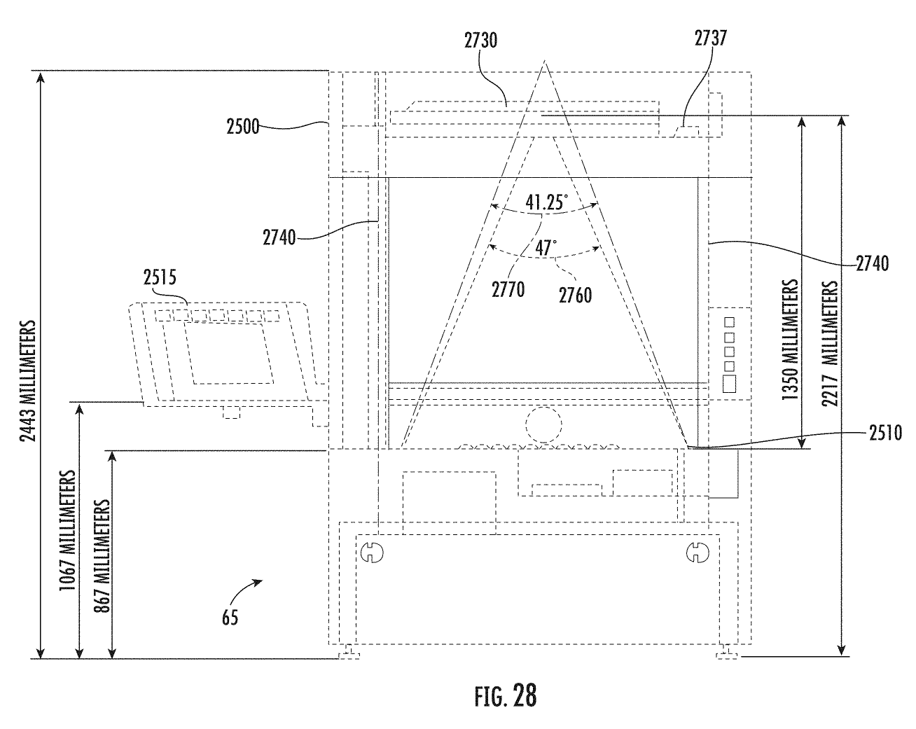

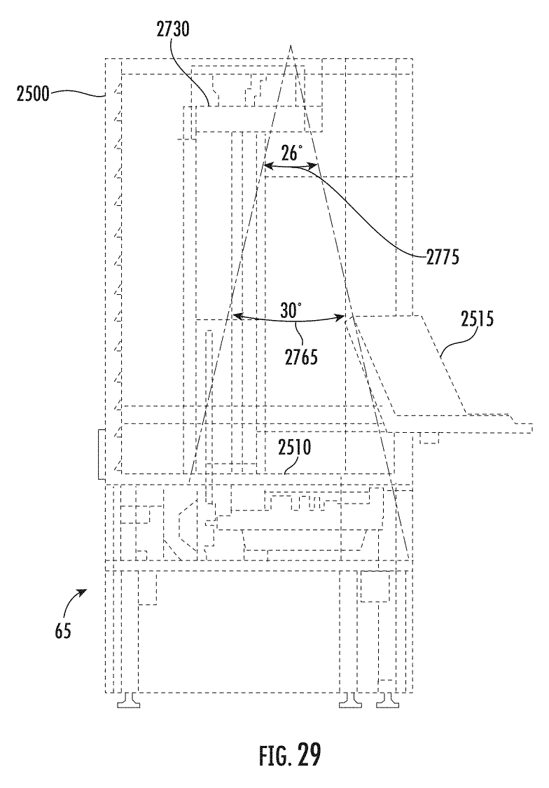

FIGS. 28-29 show exterior and interior components of laser system 65 in a planar front view and a planar side view, in an implementation. These figures show the first angle 2760 and the second angle 2765 through which the laser beam emitted by the laser is directed. The figures also show the third angle 2770 and the fourth angle 2775 through which a laser beam is directed where a ceiling height is not a constraint unlike in container 20. The vertices of the third and fourth angle are above the cabinet of the laser system.

In an implementation, table 2510 is approximately 1200 millimeters long and 900 millimeters wide and is raised above the raised floor of container 20 by approximately 867 millimeters. The bottom of computer system 2515 is 1067 millimeters above the raised floor. Table 2510 is 1350 millimeters below the vertex of first angle 2760. The vertex of the first angle is 2217 millimeters above the raised floor of the container.

In other implementations, the above lengths, widths, and heights are different. For example in alternative implementations, the table 2510 is approximately 1100-1300 millimeters long and 800-1000 millimeters wide and is raised above the raised floor of container 20 by 825-900 millimeters. The bottom of computer system 2515 is 1060-1075 millimeters above the raised floor. Table 2510 is 1340-1360 millimeters below the vertex of first angle 2760. And, the vertex of the first angle is 2210-2225 millimeters above the raised floor of the container.

Referring again to FIG. 27A, computer-controlled laser system 65 includes a galvanometric scanner 2790. Galvanometric scanner 2790 is optically positioned between laser 2730 and table 2510. The scanner sweeps the laser beam emitted from the laser through first angle 2760 and second angle 2765 onto the table.

In an implementation, the galvanometric scanner sweeps the beam through a number of parallel raster sweeps across area 2745 on the table and thereby across a garment located on the table. The raster sweeps can be along the longitudinal axis or the lateral axis of the scanned area 2745. For example, raster sweeps can be across a garment as compared to sweeps from top-to-bottom of the garment.

FIG. 27B shows the laser 2730 and a laser head 2790 of the laser, in an implementation. The laser head may include the galvanometric scanner, one or more focusing elements of the laser (e.g., focusing mirror, lenses, or other optical elements), the camera 2791, other elements, or any combination of these elements. The laser head may include an optical directing element 2790a, such as a mirror. The mirror may be a planar mirror, a convex mirror, a concave mirror, may have a conical cross-section shape (e.g., parabolic), or another shape. The mirror may be a dielectric mirror, a metallically coated mirror (e.g., aluminum, silver, or gold coated mirror), a silicon semiconductor mirror, a metal substrate mirror, or another type of mirror.

In an implementation, the mirror is the laser beam output of the laser. In an implementation that includes a lens positioned optically downstream from the mirror, the lens is the laser beam output of the laser.

The laser head may include a first rotary motor 2790b and a second rotary motor 2790c. The mirror may be connected to the first and second rotary motors to rotate the mirror so that the laser beam 2730a may be directed through the first angle 2760 and the second angle 2765 towards the table and a garment being laser finished by the laser. The first and second motors may be adapted to rotate the mirror along transverse axes.

More specifically, the first and second rotation motors rotate the mirror or another directing device along the two axes of rotations to perform the parallel raster sweeps of the laser beam across a garment. The two axes of rotation correspond to first and second angles 2760 and 2765 through which the laser beam is swept by the scanner for the parallel raster sweeps. The first axis of rotation may be parallel to the surface of the table. The first axis of rotation may also be transverse to the sides of the container. The first and second rotary motors may be galvanic devices that are adapted to rotate the directing device about the two axes of rotation. The two axes of rotation are transverse axes in an implementation. In an implementation, the axes of rotation are in a plane of the mirror where the mirror is a flat mirror. In an implementation, the axes of rotation are at the reflective surface of the mirror. The first and second motors may be connected to the mirror or connected to each other in a variety of configurations to facilitate rotation of the mirror about the transverse axes.

FIG. 27C shows the laser 2730 and a laser head 2790 of the laser, in an implementation. The laser head may include the galvanometric scanner. The laser head may include a first rotary motor 2800 and a first reflective lens element (e.g., a first mirror) 2805. The first rotary motor is connected to the first mirror. The laser head may include a second rotary motor 2810 and a second reflective lens element (e.g., a second mirror) 2815. The second rotary motor is connected to the second mirror. The laser head may include a transmissive lens element (e.g., a lens) 2820.

The first rotary motor is adapted to rotate the first mirror about a first axis. The second rotary motor is adapted to rotate the second mirror about a second axis. The first and second axes may be transverse axes. The first axis may be a vertical axis. The vertical axis may be approximately transverse to the top surface of table 2510. The vertical axis may be approximately parallel to the walls of the shipping container. The second axis may be a horizontal axis. The horizontal axis may be approximately parallel to the top surface of table 2510. The horizontal axis may be transverse to the walls of the shipping container. The first and second rotary motors may be galvanic devices that are adapted to rotate the first and second mirrors as described.

The first mirror may have an octagon shape or other shape. The second mirror may have a rectangular shape, a square shape, or other shape.

The first mirror is positioned to receive the laser beam 2730a emitted from the laser and reflect the laser beam toward the second mirror. The second mirror is positioned to receive the laser beam from the first mirror and reflect the laser beam toward the lens. The lens may be a laser beam output of the laser that is adapted to focus the laser beam toward table 2510 and toward a garment that may be positioned on the table. In an implementation that does not include a lens, the second lens is the laser beam output. The lens may focus the spot size of the laser beam to between approximately 0.2 millimeters and approximately 2 millimeters (e.g., about 0.8 millimeters). The lens is an F-theta scanning lens, in an implementation.

The first and second mirrors may be separated by a first distance 2830. The first distance may be between about 5 millimeters and about 500 millimeters. The second mirror and the lens may be separated by a second distance 2835. The second distance may be between about 5 millimeters and about 500 millimeters. The lens and the table may be separated by a third distance 2840. The third distance may be between about 1200 millimeters and about 1500 millimeters (e.g., about 1350 millimeters).

The first and second rotary motors are adapted to rotate the first and second mirrors so that the laser beam 2730a may be directed through the first angle 2760 and the second angle 2765 towards the table 2510 and towards a garment that may be located on the table and being laser finished by the laser. The scan field of the laser beam can have a variety of shapes, such as a rectangular scan field 2850, a circular scan field 2855, or other shape scan field, such as oval, elliptical, rounded rectangle, square, polygonal, or other shapes.

The first and second mirrors may be planar mirrors, convex mirrors, concave mirrors, may have conical cross-section shapes (e.g., parabolic), other shapes, or any combination of these shapes. The first and second mirrors may be dielectric mirrors, metallically coated mirrors (e.g., aluminum, silver, or gold coated mirrors), silicon semiconductor mirrors, metal substrate mirrors, other type of mirrors, or any combination of these types of mirrors.

In an implementation, a system includes a first intermodal shipping container having a first length, a first width, and a first height compliant with universal shipping container dimensions and configurations dictated by the International Organization for Standardization (ISO). The first length extends in a first direction, the first width extends in a second direction, transverse to the first direction, and the first height extends in a third direction, transverse to the first and second directions. The first intermodal shipping container includes a first computing device, including a display, a user input interface, and a software application program including code executable on a processor of the first computing device. The software application program includes code to receive a first user selection through the user input interface of a base template from a number of base templates for a garment to manufacture using the system, code to receive a second user selection through the user input interface of a pattern from a number of patterns for the garment to manufacture, and code to generate a preview image on the display of the selected base template and the selected pattern such that an appearance of the preview image is representative of the garment after manufacture.

The first intermodal shipping container includes a laser device that includes a laser head having a laser beam output, a workpiece surface positioned at a first distance from the laser head, and a first memory to receive a laser input file associated with the selected pattern selected at the first computing device. Via the laser head, a laser beam can be emitted through the laser beam output and is capable of striking a number of positions of the workpiece surface. During manufacture of the garment, based on the laser input file in the first memory, the laser device can direct the laser beam to create the selected pattern on an outer surface of a garment, corresponding to the selected base template, that is placed on the workpiece surface.

In an implementation, the laser device is a carbon dioxide laser. The laser device includes a first reflective lens element that is connected to a first rotary motor, a second reflective lens element that is connected to a second rotary motor, and a transmissive lens element. A laser beam of the laser device can be directed at the first reflective lens element, which redirects the laser beam to the second reflective lens element based on an angular orientation of the first rotary motor, which redirects the laser beam to the transmissive lens element based on an angular orientation of the second rotary motor. A first axis about which the first angular orientation rotates is transverse a second axis about which the second angular orientation rotates, and the laser beam passes through the transmissive lens element as the laser beam output of the laser head.

In an implementation, the system includes a second intermodal shipping container. The second intermodal shipping includes the first length, the first width, and the first height, the first length extends in a fourth direction, the first width extends in a fifth direction, transverse to the fourth direction, and the first height extends in a sixth direction, transverse to the fourth and fifth directions. The second intermodal shipping includes a first water tank that includes a first input port and a first output port. The second intermodal shipping includes a first hose, a second hose, and a third hose. The second intermodal shipping includes a water recycling device that includes a second input port and a second output port where the first hose is connected to the first input port and the second output port.

The second intermodal shipping includes a washing machine. The washing machine includes a third input port, a third output port, and a washing cycle to wash a garment having a pattern created by a laser on its outer surface. The second hose is connected to the first output port and the third input port and the third hose is connected between the third output port and the second input port.

The second intermodal shipping includes a dryer that includes a drying cycle to dry the washed garment having the pattern created by a laser on its outer surface from the washing machine. After drying, the garment has an appearance that resembles the preview image generated by the software application program.

In an implementation, the first distance extends in the third direction. In an implementation, the first distance extends in the second direction. In an implementation, the first distance extends in the first direction.

The first distance can extend in the third direction, the first distance can be less than the first height. The laser beam can be directed to positions, along the first direction, of the workpiece surface based on a first sweep angle of the laser beam. The laser beam can be directed to positions, along the second direction, of the workpiece surface based on a second sweep angle of the laser beam.

The first sweep angle can be the same as or different from the second sweep angle. The first sweep angle can be about 42 degrees or greater. The first distance can be about 2.2 meters or less. The second sweep angle can be about 26 degrees or greater. The first sweep angle can be about 26 degrees or greater, and the second sweep angle can be about 42 degrees or greater. The first sweep angle can be about 42 degrees or greater, and the second sweep angle can be about 42 degrees or greater.

In an implementation, a system includes a first intermodal shipping container having a first length, a first width, and a first height compliant with universal shipping container dimensions and configurations dictated by the International Organization for Standardization (ISO). The first length extends in a first direction, the first width extends in a second direction, transverse to the first direction, and the first height extends in a third direction, transverse to the first and second directions. The first intermodal shipping container includes a first water tank that includes a first input port and a first output port. The first intermodal shipping container includes, a first hose, a second hose, and a third hose.

The first intermodal shipping container includes a water recycling device that includes a second input port and a second output port. The first hose is coupled to the first input port and the second output port.

The first intermodal shipping container includes a washing machine that includes a third input port, a third output port, and a washing cycle to wash a garment having a pattern created by a laser on its outer surface. The second hose is coupled to the first output port and the third input port and the third hose is coupled between the third output port and the second input port.

The pattern for the garment was previously selected and previewed on a first computing device that includes a display, a user input interface, and a software application program that includes code that is executable on a processor of the first computing device to display on the display a preview image of the selected pattern with an image of the garment.

The software application program includes code to receive a first user selection through the user input interface of a base template from a number of base templates for the garment, code to receive a second user selection through the user input interface of the selected pattern from a plurality of patterns for the garment, and code to generate the preview image displayed on the number of the selected base template and the selected pattern such that an appearance of the preview image is representative of the garment after manufacture.

The first intermodal shipping container includes a first dryer that includes a drying cycle to dry the washed garment having the pattern created by a laser on its outer surface and washed by the washing machine. After drying, the garment has an appearance that resembles the preview image generated by the software application program.

In an implementation, the system includes a second intermodal shipping container having the first length, the first width, and the first height. The second intermodal shipping container includes the first computing device that includes the display, the user input interface, and the software application program.

The second intermodal shipping container includes the laser. The laser includes a laser head having a laser beam output, a workpiece surface positioned at a first distance from the laser head, and a first memory to receive a laser input file associated with the selected pattern selected at the first computing device. Via the laser head, a laser beam is emitted through the laser beam output and is capable of striking a number of positions of the workpiece surface. During manufacture of the garment, based on the laser input file in the first memory, the laser device will direct the laser beam to create the selected pattern on an outer surface of a garment, corresponding to the selected base template.

In an implementation, the first intermodal shipping container includes a first washer, coupled to the water recycling device, a second washer, coupled to the water recycling device, positioned in a row adjacent the first washer, and a third washer, coupled to the water recycling device, positioned in the row adjacent the second washer.

In an implementation, the first intermodal shipping container includes a first dryer, a second dryer, stacked above the first dryer, a third dryer, positioned in a row adjacent the first dryer, and a fourth dryer, stacked about the third dryer, positioned in a row adjacent the second dryer. The first intermodal shipping container may includes a sink, coupled to the water recycling device.

In an implementation, a system includes a first intermodal shipping container having a first length, a first width, and a first height compliant with universal shipping container dimensions and configurations dictated by the International Organization for Standardization (ISO). The first length extends in a first direction, the first width extends in a second direction, transverse to the first direction, and the first height extends in a third direction, transverse to the first and second directions. The first intermodal shipping container includes a first computing device that includes a display, a user input interface, and a first software application program comprising code executable on a processor of the first computing device.

The first software application program includes code to receive a first user selection through the user input interface of a base template from a number of base templates for a garment to manufacture using the system, code to receive a first user selection through the user input interface of a pattern from a number of base templates for the garment to manufacture, and code to generate a preview image on the display of the selected base template and the selected pattern such that an appearance of the preview image is representative of the garment after manufacture.

The first intermodal shipping container includes a laser device that includes a laser head having a laser beam output, a workpiece surface positioned at a first distance from the laser head, and a first memory to receive a laser input file from a second memory that is external to the laser device. The laser input file is representative of the selected base template and the selected pattern that is used in the manufacture of the garment. Via the laser head, a laser beam is emitted through the laser beam output and is capable of striking a number of positions of the workpiece surface, and during manufacture of the garment, based on the laser input file in the first memory, the laser device will direct the laser beam to create the selected pattern on an outer surface of a garment, corresponding to the selected base template, that is placed on the workpiece surface.

A side opening on a first side of the first intermodal shipping container, wherein the side opening extends in the first direction and third direction. Via the side opening, the laser device is accessible.

The system includes a second intermodal shipping container having the same dimensions as the first intermodal shipping container. The second intermodal shipping container includes a water tank that includes a tank input and a tank output. The second intermodal shipping container includes a water treatment device that includes a water treatment input and a water treatment output. The water treatment output is connected to the tank input.

The second intermodal shipping container includes a washing machine that includes a washer input and a washer output. The washer input is connected to the tank output and the washer output is coupled to the water treatment input. The washing machine includes a washing cycle to wash the garment having a pattern created by a laser on its outer surface. Water used in washing the garment having a pattern created by a laser on its outer surface is output through the washer output and input through the water treatment input to the water treatment device, where the water is treated, and the treated water is output through the water treatment output and input via the tank input to the water tank to store the treated water for use in subsequent washing cycles at the washing machine.

The second intermodal shipping container includes a dryer that includes a drying cycle to dry the washed garment having the pattern created by a laser on its outer surface from the washing machine. After drying, the garment has an appearance that resembles the preview image generated by the software application program.

A side opening on a first side of the second intermodal shipping container, wherein the side opening extends in the first direction and third direction. Via the side opening of the second intermodal shipping container, the washing machine is accessible. The first intermodal shipping container is positioned with respect to the second intermodal shipping container such the side opening of the first intermodal shipping container is across from the side opening of the second intermodal shipping container.

In an implementation, the system includes a deck that is positioned between the first side of the first intermodal shipping container and the first side of the second intermodal shipping container. The deck is a walkway joining the side opening of the first intermodal shipping container with the side opening of the second intermodal shipping.

The side opening of the first intermodal shipping container includes at least one of a sliding door or a sliding glass door, the side opening of the second intermodal shipping container includes at least one of a sliding door or a sliding glass door, and the side opening of the first intermodal shipping container faces the side opening of the second intermodal shipping container.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A system comprising:
a first intermodal shipping container having a first length, a first width, and a first height compliant with universal shipping container dimensions and configurations dictated by the International Organization for Standardization (ISO), wherein the first length extends in a first direction, the first width extends in a second direction, transverse to the first direction, and the first height extends in a third direction, transverse to the first and second directions, and the first intermodal shipping container comprises:
a first computing device, comprising a display, a user input interface, and a software application program comprising code executable on a processor of the first computing device,
wherein the software application program comprises code to receive a first user selection through the user input interface of a base template from a plurality of base templates for a garment to manufacture using the system, code to receive a second user selection through the user input interface of a pattern from a plurality of patterns for the garment to manufacture, and code to generate a preview image on the display of the selected base template and the selected pattern such that an appearance of the preview image is representative of the garment after manufacture; and
a laser device, comprising a laser head having a laser beam output, a workpiece surface positioned at a first distance from the laser head, and a first memory to receive a laser input file associated with the selected pattern selected at the first computing device, wherein via the laser head, a laser beam is emitted through the laser beam output and is capable of striking a plurality of positions of the workpiece surface, and
during manufacture of the garment, based on the laser input file in the first memory, the laser device will direct the laser beam to create the selected pattern on an outer surface of a garment, corresponding to the selected base template, that is placed on the workpiece surface.

2. The system of claim 1 wherein the laser device is a carbon dioxide laser and comprises:
a first reflective lens element, coupled to a first rotary motor;
a second reflective lens element, coupled to a second rotary motor; and
a transmissive lens element, wherein a laser beam of the laser device is directed at the first reflective lens element, which redirects the laser beam to the second reflective lens element based on an angular orientation of the first rotary motor, which redirects the laser beam to the transmissive lens element based on an angular orientation of the second rotary motor, wherein a first axis about which the first angular orientation rotates is transverse a second axis about which the second angular orientation rotates, and the laser beam passes through the transmissive lens element as the laser beam output of the laser head.

3. The system of claim 1 comprising a second intermodal shipping container, wherein the second intermodal shipping container comprises:
the first length, the first width, and the first height, the first length extends in a fourth direction, the first width extends in a fifth direction, transverse to the fourth direction, and the first height extends in a sixth direction, transverse to the fourth and fifth directions;
a first water tank comprising a first input port and a first output port;
a first hose, a second hose, and a third hose;
a water recycling device comprising a second input port and a second output port, wherein the first hose is coupled to the first input port and the second output port;
a washing machine comprising a third input port, a third output port, and a washing cycle to wash a garment having a pattern created by a laser on its outer surface, wherein the second hose is coupled to the first output port and the third input port and the third hose is coupled between the third output port and the second input port; and
a dryer comprising a drying cycle to dry the washed garment having the pattern created by a laser on its outer surface from the washing machine, wherein after drying, the garment has an appearance that resembles the preview image generated by the software application program.

4. The system of claim 1 wherein the first distance extends in the third direction.

5. The system of claim 1 wherein the first distance extends in the second direction.

6. The system of claim 1 wherein the first distance extends in the first direction.

7. The system of claim 1 wherein the first distance extends in the third direction, the first distance is less than the first height,
the laser beam can be directed to positions, along the first direction, of the workpiece surface based on a first sweep angle of the laser beam, and
the laser beam can be directed to positions, along the second direction, of the workpiece surface based on a second sweep angle of the laser beam.

8. The system of claim 7 wherein the first sweep angle of the laser head is the same as the second sweep angle.

9. The system of claim 7 wherein the first sweep angle of the laser head is different from the second sweep angle.

10. The system of claim 7 wherein the first sweep angle of the laser head is about 42 degrees or greater.

11. The system of claim 10 wherein the first distance is about 2.2 meters or less.

12. The system of claim 10 wherein the second sweep angle is about 26 degrees or greater.

13. The system of claim 7 wherein the first sweep angle of the laser head is about 26 degrees or greater, and the second sweep angle of the laser head is about 42 degrees or greater.

14. The system of claim 7 wherein the first sweep angle of the laser head is about 42 degrees or greater, and the second sweep angle of the laser head is about 42 degrees or greater.

15. A system comprising:
a first intermodal shipping container having a first length, a first width, and a first height compliant with universal shipping container dimensions and configurations dictated by the International Organization for Standardization (ISO), wherein the first length extends in a first direction, the first width extends in a second direction, transverse to the first direction, and the first height extends in a third direction, transverse to the first and second directions, and the first intermodal shipping container comprises:
a first water tank comprising a first input port and a first output port;
a first hose, a second hose, and a third hose;
a water recycling device comprising a second input port and a second output port, wherein the first hose is coupled to the first input port and the second output port;
a washing machine comprising a third input port, a third output port, and a washing cycle to wash a garment having a pattern created by a laser on its outer surface, wherein the second hose is coupled to the first output port and the third input port and the third hose is coupled between the third output port and the second input port, and
the pattern for the garment was previously selected and previewed on a computing device comprising a display; and
a first dryer comprising a drying cycle to dry the washed garment having the pattern created by a laser on its outer surface from the washing machine, wherein after drying, the garment has an appearance that resembles the preview image previously displayed on the computing device.

16. The system of claim 15 wherein the first intermodal shipping container comprises:
a first washer, coupled to the water recycling device;
a second washer, coupled to the water recycling device, positioned in a row adjacent the first washer;
a third washer, coupled to the water recycling device, positioned in the row adjacent the second washer;
a first dryer;
a second dryer, stacked above the first dryer;
a third dryer, positioned in a row adjacent the first dryer; and
a fourth dryer, stacked about the third dryer, positioned in a row adjacent the second dryer.

17. The system of claim 15 wherein the first intermodal shipping container comprises a sink, coupled to the water recycling device.

18. A system comprising:
a first intermodal shipping container having a first length, a first width, and a first height compliant with universal shipping container dimensions and configurations dictated by the International Organization for Standardization (ISO), wherein the first length extends in a first direction, the first width extends in a second direction, transverse to the first direction, and the first height extends in a third direction, transverse to the first and second directions, and the first intermodal shipping container comprises:
a first computing device, comprising a display, a user input interface, and a first software application program comprising code executable on a processor of the first computing device,
wherein the first software application program comprises code to receive a first user selection through the user input interface of a base template from a plurality of base templates for a garment to manufacture using the system, code to receive a first user selection through the user input interface of a pattern from a plurality of base templates for the garment to manufacture, and code to generate a preview image on the display of the selected base template and the selected pattern such that an appearance of the preview image is representative of the garment after manufacture; and
a laser device, comprising a laser head having a laser beam output, a workpiece surface positioned at a first distance from the laser head, and a first memory to receive a laser input file from a second memory that is external to the laser device, wherein the laser input file is representative of the selected base template and the selected pattern that is used in the manufacture of the garment,
via the laser head, a laser beam is emitted through the laser beam output and is capable of striking a plurality of positions of the workpiece surface, and
during manufacture of the garment, based on the laser input file in the first memory, the laser device will direct the laser beam to create the selected pattern on an outer surface of a garment, corresponding to the selected base template, that is placed on the workpiece surface;
a side opening on a first side of the first intermodal shipping container, wherein the side opening extends in the first direction and third direction, wherein via the side opening, the laser device is accessible; and
a second intermodal shipping container having the same dimensions as the first intermodal shipping container, wherein the second intermodal shipping container comprises:
a water tank, comprising a tank input and a tank output;
a water treatment device, comprising a water treatment input and a water treatment output, wherein the water treatment output is coupled to the tank input;
a washing machine, comprising a washer input and a washer output, wherein the washer input is coupled to the tank output and the washer output is coupled to the water treatment input,
the washing machine comprises washing cycle to wash the garment having a pattern created by a laser on its outer surface,
water used in washing the garment having a pattern created by a laser on its outer surface is output through the washer output and input through the water treatment input to the water treatment device, where the water is treated, and the treated water is output through the water treatment output and input via the tank input to the water tank to store the treated water for use in subsequent washing cycles at the washing machine,
a dryer comprising a drying cycle to dry the washed garment having the pattern created by a laser on its outer surface from the washing machine, wherein after drying, the garment has an appearance that resembles the preview image generated by the software application program;
a side opening on a first side of the second intermodal shipping container, wherein the side opening extends in the first direction and third direction, wherein via the side opening of the second intermodal shipping container, the washing machine is accessible, and
the first intermodal shipping container is positioned with respect to the second intermodal shipping container such the side opening of the first intermodal shipping container is across from the side opening of the second intermodal shipping container.

19. The system of claim 18 comprising a deck, positioned between the first side of the first intermodal shipping container and the first side of the second intermodal shipping container, wherein the deck is a walkway joining the side opening of the first intermodal shipping container with the side opening of the second intermodal shipping.

20. The system of claim 18 wherein the side opening of the first intermodal shipping container comprises at least one of a sliding door or a sliding glass door, the side opening of the second intermodal shipping container comprises at least one of a sliding door or a sliding glass door, and the side opening of the first intermodal shipping container faces the side opening of the second intermodal shipping container.
